(19) United States
(12) Patent Application Publication
(10) Pub. No.: US 2026/0286154 A1
(43) Pub. Date: Sep. 24, 2026

(54) SECURITY INKS AND MACHINE READABLE SECURITY FEATURES

(71) Applicant: SICPA HOLDING SA, Prilly (CH)

(72) Inventors: Patrick VEYA, Aclens (CH); Lazaro LOPEZ SANCHEZ, Valeyres-sous-Ursins (CH)

(21) Appl. No.: 19/475,391

(22) PCT Filed: Apr. 10, 2024
(86) PCT No.: PCT/EP2024/059687

§ 371 Date: Oct. 14, 2025

(30) Foreign Application Priority Data
Apr. 13, 2023 (EP) 23167755.0

(51) Int. Cl. C09D 11/107; B41M 3/14; C09D 11/033; C09D 11/037

(52) U.S. Cl. CPC C09D 11/107; B41M 3/14; C09D 11/033; C09D 11/037

(57) ABSTRACT

The present invention relates to the field of security inks suitable for printing machine readable security features on substrate. security documents or articles as well as machine readable security feature made from said security inks, and security documents comprising a machine readable security feature made from said security inks. In particular, the invention provides security inks comprising one or more IR absorbing materials wherein said security ink allows the production of a machine readable security feature

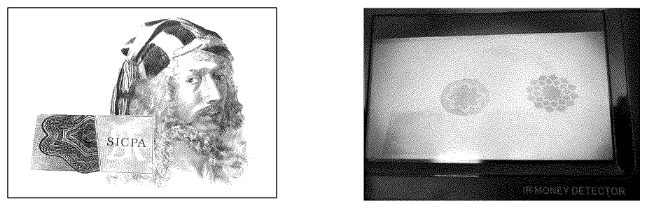

The present invention relates to the field of water-based security inks suitable for printing machine readable security features on substrates, in particular on security documents or articles.

### BACKGROUND OF THE INVENTION

With the constantly improving quality of color photocopies and printings and in an attempt to protect security documents such as banknotes, value documents or cards, transportation tickets or cards, tax banderols, and product labels that have no reproduceable effects against counterfeiting, falsifying or illegal reproduction, it has been the conventional practice to incorporate various security features in these documents.

Security features, e.g. for security documents, can be classified into “overt” and “covert” security features. Overt security features are easily detectable with the unaided human senses, e.g. such features may be visible and/or detectable via the tactile senses while still being difficult to produce and/or to copy, whereas covert security features typically require specialized equipment and knowledge for their detection.

Machine readable inks, such as for example magnetic inks, luminescent inks and infrared (IR) absorbing inks, have been widely used in the field of security documents, in particular for banknotes printing, to produce covert security features. In the field of security and protecting value documents and value commercial goods against counterfeiting, falsifying and illegal reproduction, it is known in the art to apply machine readable security inks by different printing processes including printing processes using highly viscous or pasty inks such as offset printing, letterpress printing and intaglio printing (also referred in the art as engraved steel die or copper plate printing), liquid inks such as rotogravure printing, flexography printing, screen printing and inkjet printing.

Security features comprising infrared (IR) absorbing materials are widely known and used in security applications. Commonly used IR absorbing materials in the field of security are based on the absorption of electromagnetic radiation due to electronic transitions in a spectral range between 780 nm and 1400 nm (range provided by CIE (Commission Internationale de l'Eclairage)), this part of the electromagnetic spectrum being usually referred to as the NIR-domain. For example, IR absorbing features have been implemented in banknotes for use by automatic currency processing equipment, in banking and vending applications (automatic teller machines, automatic vending machines, etc.), in order to recognize a determined currency and to verify its authenticity, in particular to discriminate it from replicas made by color copiers. IR absorbing materials include organic compounds, inorganic materials, glasses comprising substantial amounts of IR-absorbing atoms, ions or molecules. Typical examples of IR absorbing compounds include among others carbon black, quinone-diimmonium or ammonium salts, polymethines (e.g. cyanines, squaraines, croconaines), phthalocyanine or naphthalocyanine type (IR-absorbing pi-system), dithiolenes, quaterrylene diimides, metal salts, metal oxides and metal nitrides.

Due to its strong absorption in the visible domain, carbon black is not a preferred security material since said strong absorption limits the freedom for realizing designs of a security document to be protected against counterfeit or illegal reproduction.

Ideally, security features comprising infrared (IR) absorbing materials for authentication purposes should not absorb in the visible range (400 nm to 700 nm), such as to allow its use in all types of visibly colored inks and also in markings which are invisible or partially visible to the naked eye, and at the same time display a strong absorption in the infrared or near-infrared range, such as to allow its easy recognition by standard currency processing equipment.

Organic NIR absorbers are usually of limited use in security applications because of their inherent low thermal stability, low lightfastness and the complexity of their production.

Inorganic IR absorbing compounds exhibiting improved properties have been disclosed in WO 2007/060133 A2 and in WO 2020/239740 A1. WO 2007/060133 A2 discloses intaglio printing inks and WO 2020/239740 A1 discloses liquid inks, said inks comprising an IR absorbing material consisting of a transition element compound whose IR-absorption is a consequence of electronic transitions within the d-shell of transition element atoms or ions. However, there is some increasing concerns about solvent-based inks and an increasing impetus to replace or supplement them with water-based counterparts due to the environmental toxicity and inflammability problems posed by the use of volatile organic solvents.

UV-curable inks may be considered to be expensive and requiring complex equipments. Furthermore, the required high ratio between the binder and the pigments renders difficult the preparation of matte printed features. Water-based inks comprising polyurethane resins suffer from a reduced stability upon storage due to a viscosity increase and water-based inks comprising acrylic resins and the IR absorbing material described in WO 2020/239740 A1 and WO 2007/060133 A2 suffer from poor optical properties in terms of yellowing upon ageing.

Therefore, a need remains for water-based security inks comprising one or IR absorbing materials for printing machine readable security features which have advantages over the prior art and exhibit good physico-chemical properties while maintaining good optical characteristics in the visible and near IR ranges upon use and time.

### SUMMARY

Accordingly, it is an object of the present invention to overcome the deficiencies of the prior art as discussed above.

In a first aspect, the present invention provides a security ink for printing a machine readable security feature, said ink having a viscosity between 100 and 3000 mPa s at 25° C., a pH between about 7.0 and about 9.0, and comprising:
a) water in an amount of at least about 45 wt-%, preferably from about 45 wt-% to about 75 wt-%,
b) a binder comprising one or more acrylic resins, said binder being present in an amount from about 10 wt-% to about 40 wt-%,
c) one or more IR absorbing materials in a total amount from about 5 wt-% to about 25 wt-%, preferably from about 7 wt-% to about 15 wt-%, said one or more IR absorbing materials comprising copper (Cu) and one or more anions selected from the group consisting of phosphates (PO₄³⁻), hydrogenophosphates (HPO₄²⁻), pyrophosphates (P₂O₇⁴⁻), metaphosphates (P₃O₉³⁻), fluorides, chlorides, sulfates (SO₄²⁻) and hydroxides (OH); preferably selected form the group consisting of phosphates (PO₄³⁻), hydrogenophosphates (HPO₄²⁻), pyrophosphates (P₂O₇⁴⁻), metaphosphates (P₃O₉³⁻), polyphosphates and hydroxides (OH), more preferably selected from the group consisting of phosphates (PO₄³⁻) and hydroxides (OH⁻), and
d) one or more zinc aluminum phosphate compounds in an amount from about 0.125 wt-% to about 5.0 wt-%, wherein a ratio (R) between the amount of the one or more zinc aluminum phosphate compounds versus the sum of the amount of the one or more zinc aluminum phosphate compounds and the one or more IR absorbing materials is between about 2.0 and about 20,
e) optionally one or more additives selected from fillers, waxes, surfactants, anti-foaming agents, thickening agents and mixtures thereof, the weight percents being based on the total weight of the security ink.

Also described and claimed therein are uses of the security inks described herein for printing a machine readable security feature.

Also described and claimed therein are machine readable security feature made from the security ink described herein

Also described and claimed therein are methods for producing the machine readable security features described herein, wherein said methods comprise a step a) of applying by a screen printing process the security ink described herein onto a substrate.

Also described and claimed therein are security documents comprising the machine readable security feature described herein.

Also described and claimed therein are methods for authenticating the security document described herein, said methods comprising the steps of:
a) providing the security document described herein and comprising the machine readable security feature made of the ink described herein;
b) illuminating the machine readable security feature at at least one wavelength, or illuminating the machine readable security feature at at least two wavelengths, wherein one of said at least two wavelengths is in the visible range and another one of said at least two wavelengths is in the IR range,
c) detecting the optical characteristics of the machine readable security feature through sensing of light reflected or transmitted by said machine readable security feature at at least one wavelength, or detecting the optical characteristics of the machine readable security feature through sensing of light reflected or transmitted by said machine readable security feature at at least two wavelengths, wherein one of said at least two wavelengths is in the visible range and another one of said at least two wavelengths is in the IR range, and
d) determining the security document authenticity from the detected optical characteristics of the machine readable security feature.

The water-based security inks described herein advantageously allow to produce machine readable security features exhibiting improved performance in terms of optical properties in the visible, including reduced yellowing and/or greening upon ageing, while maintaining good optical characteristics in the near IR or IR range upon use and time. In addition to the environment friendly nature of the water-based security inks described herein (inks lacking or comprising very limited amount of volatile organic components), the improved optical properties of security features obtained thereof allow their integration in and/or on security documents, in particular banknotes and allow a freedom in terms of design for subsequent security printing steps as described hereafter. Advantageously, the water-based security inks described herein may be used in paper mills where all inks are prepared from water-based compositions.

### BRIEF DESCRIPTION OF DRAWINGS

The sole FIGURE shows pictures (sole FIGURE left: under visible artificial light and captured using a phone camera; and sole FIGURE right: under near IR light and captured using a near IR camera) of a machine readable security feature comprising an IR-absorbing layer made with a dried security ink according to the present invention and having the shape of two circular geometric patterns and, on top of said IR-absorbing layer and partially covering it, an IR-transparent layer made of an intaglio ink.

### DETAILED DESCRIPTION

The following definitions are to be used to interpret the meaning of the terms discussed in the description and recited in the claims.

As used herein, the article “a” indicates one as well as more than one and does not necessarily limit its referent noun to the singular.

As used herein, the terms “about” means that the amount or value in question may be the value designated or some other value about the same. The phrases are intended to convey that similar values within a range of ±5% of the indicated value promote equivalent results or effects according to the invention.

As used herein, the term “and/or” or “or/and” means that either all or only one of the elements of said group may be present. For example, “A and/or B” shall mean “only A, or only B, or both A and B”.

As used herein, the term “at least” is meant to define one or more than one, for example one or two or three.

The term “security document” refers to a document which is usually protected against counterfeit or fraud by at least one security feature. Examples of security documents include without limitation value documents and value commercial goods.

The term “yellowing” and “greening” refers to the tendency of some inks or coatings to become yellowish and greenish, hence to change their color, upon drying and/or ageing. The yellowing and greening behavior is characterized by the variation of the color upon drying, curing and/or ageing given by a* (greening) and b* (yellowing) parameter of the CIE (1976) system, wherein a* is the horizontal coordinate the values of which range from −80 (green) to +80 (red) and b* is the horizontal coordinate the values of which range from −80 (blue) to +80 (yellow). More details concerning CIE (1976) system can be found in Physics, Chemistry and Technology Vol. 3, No 2, 2005, pp. 205-216. In particular, the yellowing and greening behavior of an ink or coating may be characterized by the variation of a* and b* upon time either under normal conditions (e.g. laboratory conditions) or under thermal ageing (e.g. in an oven at 40° C.).

The present invention provides security inks comprising the one or more IR absorbing materials described herein for printing machine readable security features. As used herein, the term “machine readable security feature” refers to an element which exhibits at least one distinctive property which is detectable by a device or machine and which can be comprised in a layer so as to confer a way to authenticate said layer or article comprising said layer by the use of a particular equipment for its authentication. The machine readable properties of the security feature described herein are embodied by the one or more absorbing materials described herein that are comprised in the security ink described herein.

The security inks described herein have a viscosity between about 100 mPa s and about 3000 mPa s at 25° C., wherein the viscosity measurements are carried out with a Brookfield viscometer (model “RVDV-| Prime”), the spindle and rotation speed (rpm) being adapted according to the following viscosity ranges: spindle 21 at 100 rpm for viscosity values between 100 and 500 mPa s; spindle 27 at 100 rpm for viscosity values between 500 mPa s and 2000 mPa s; and spindle 27 at 50 rpm for viscosity values between 2000 mPa s and 3000 mPa s.

The security inks described herein have a pH between about 7.0 and about 9.0, preferably between about 7.5 and 9.0, to ensure a good stability of said inks upon storage, in particular to avoid flocculation and an increase of the viscosity upon storage.

The one or more IR absorbing materials described herein are present in the security ink described herein in an amount from about 5 wt-% to about 25 wt-%, more preferably in an amount from about 7 wt-% to about 15 wt-%, the weight percents being based on the total weight of the security ink. The one or more IR absorbing materials described herein are suitable for producing machine readable security features. The one or more IR absorbing materials described herein comprise copper (Cu) and one or more anions selected from the group consisting of phosphates (PO₄³⁻), hydrogenophosphates (HPO₄²⁻), pyrophosphates (P₂O₇⁴⁻), metaphosphates (P₃O₉³⁻), fluorides, chlorides, sulfates (SO₄²⁻) and hydroxides (OH); preferably selected form the group consisting of phosphates (PO₄³⁻), hydrogenophosphates (HPO₄²⁻), pyrophosphates (P₂O₇⁴⁻), metaphosphates (P₃O₉³⁻), polyphosphates and hydroxides (OH), more preferably selected from the group consisting of phosphates (PO₄³⁻) and hydroxides (OH). Examples include without limitation example copper(II) fluoride (CuF₂), copper hydroxyfluoride (CuFOH), copper hydroxide (Cu(OH)₂), copper phosphate hydrate (Cu₃(PO₄)₂·2H₂O), anhydrous copper phosphate (Cu₃(PO₄)₂), basic copper(II) phosphates (e.g. Cu₂PO₄(OH), Cu₃(PO₄)(OH)₃, “Cornetite”, Cu₅(PO₄)₃(OH)₄, “Pseudomalachite”, CuAl₆(PO₄)₄(OH)₈·5H₂O “Turquoise”, etc.), copper(II) pyrophosphate (Cu₂(P₂O₇)·3H₂O), anhydrous copper(II) pyrophosphate (Cu₂(P₂O₇)), copper(II) metaphosphate (Cu(PO₃)₂, more correctly written as Cu₃(P₃O₉)₂). According to a preferred embodiment, at least one of the one or more IR absorbing materials described herein is Cu₂PO₄(OH) (CAS No: 12158-74-6) preferably Cu₂PO₄(OH) having the libethenite crystal structure.

The one or more IR absorbing materials described herein preferably have a specific particle size. Herein the term “size” denotes a statistical property of the IR absorbing materials described herein. As known in the art, each of said one or more IR absorbing materials can be independently characterized by measuring a particle size distribution (PSD) of a sample. Such PSDs typically describe the fractional amount (relative to total number, weight or volume) of particles in the sample as a function of a size-related characteristic of individual particles. A commonly used size-related characteristic describing individual particles is the “circle equivalent” (CE) diameter, which corresponds to the diameter of a circle that would have the same area as an orthographic projection of the material. In this application, the following values are reported:
d(v,50) (hereafter abbreviated as d50) is the value of the CE diameter, in microns, which separates the PSD in two parts of equal cumulated volume: the lower part represents 50% of the cumulated volume of all particles, corresponding to those particles with a CE diameter smaller than d50; the upper part represents 50% of the cumulated volume of particles, corresponding to those particles with a CE diameter larger than d50. D50 is also known as the median of the volume distribution of particles, d(v,98) (hereafter abbreviated as d98 is the value of the CE diameter, in microns, which separates the PSD into two parts with different cumulated volumes such that the lower part represents 98% of the cumulated volume of all particles, corresponding to those particles with a CE diameter smaller than d98, and the upper part represents 2% of the cumulated volume of particles, with a CE diameter larger than d98.

Each of the one or more IR absorbing materials described herein preferably has a median particle size (d50 value) from about 0.01 μm to about 50 μm, more preferably from about 0.1 μm to about 20 μm and even more preferably from about 1 μm to about 10 μm, and/or has a particle size (d98 value) from about 0.1 μm to about 100 μm, more preferably from about 1 μm to about 50 μm and even more preferably from about 5 μm to about 40 μm. A variety of experimental methods are available to measure PSDs including without limitation sieve analysis, electrical conductivity measurements (using a Coulter counter), laser diffractometry (e.g. Malvern Mastersizer), acoustic spectroscopy (e.g. Quantachrome DT-100), differential sedimentation analysis (e.g. CPS devices), and direct optical granulometry. The d50 and d98 values provided therein have been measured by laser diffractometry with the following conditions: instrument: (Cilas 1090); sample preparation: the IR absorbing material was added to distilled water, until the laser obscuration reached the operating level of 13-15%, and the measurement was performed according to the ISO norm 13320.

The security inks described herein are water-based thermal drying inks and are particularly suitable to be applied by a printing process preferably selected form the group consisting of gravure printing, flexography printing and screen printing, more preferably screen printing, onto a substrate such as those described herein. Thermal drying security inks consist of security inks which are dried by hot air, infrared or by a combination thereof. Thermal drying security inks typically consist of about 20 wt-% to about 60 wt-%, preferably from about 25 wt-% to about 55 wt-%, solid content, that remains on the printed substrate and the remaining consisting of one or more water/solvents which are evaporated as a result of drying.

Screen printing security inks are known in the art as requiring a low viscosity. Typically, security inks suitable for screen printing processes have a viscosity in the range from about 100 mPa s to about 3000 mPa s, preferably in the range from about 200 mPa s to about 2500 mPa s, more preferably from about 200 mPa s to about 2000 mPa s at 25° C. (using for example a Brookfield machine “RVDV-I Prime”, spindle 21 at 100 rpm, spindle 27 at 100 rpm or spindle 27 at 50 rpm).

Therma drying screen printing security inks allows the preparation of the machine readable security feature described herein (i.e. dried security ink layer) having a value typically between about 3 μm and about 10 μm.

The security inks described herein comprise least about 45 wt-%, preferably from about 45 wt-% to about 75 wt-%, of water, the weight percents being based on the total weight of the security ink.

The security inks described herein comprise from about 10 wt-% to about 40 wt-%, preferably from about 15 wt-% to 30 about wt-% of the binder comprising one or more acrylic resins, the weight percents being based on the total weight of the security ink.

Preferably, the binder described herein is preferably in the form an aqueous composition comprising the one or more acrylic resins described herein and the optional additional resins described herein, in particular an aqueous emulsion comprising the one or more acrylic resins described herein and the optional additional resins described herein or an aqueous dispersion comprising the one or more acrylic resins described herein and the optional additional resins described herein. Should the one or more acrylic resins be used as aqueous compositions, in particular aqueous emulsions or aqueous dispersions, the amounts of said resins provided herein consist of the solid/dry content of said resins.

The one or more acrylic resins may be homopolymers (i.e. polymers resulting from the polymerization of acrylic acid or methacrylic acid) or copolymer, preferably, the one or more acrylic resins are copolymers. Acrylic copolymers refer to polymers resulting from the copolymerization of acrylic acid and/or methacrylic acid with one or more additional monomers or prepolymers.

Preferred monomers include e.g. alkyl (meth)acrylates, such as methyl acrylate, propyl acrylate and the like, aryl (meth)acrylates such as phenyl acrylate, benzyl acrylate and the like, styrene and substituted styrenes, vinyl ethers, such as methyl vinyl ether, hexyl vinyl ether, benzyl vinyl ether and the like, vinyl halides, such as vinyl chloride and vinylidene chloride, vinyl ketones, such as methyl vinyl ketone, vinyl carboxylates such as vinyl acetate and vinyl benzoate, unsaturated olefins, such as ethylene, propylene or butylene, allyl compounds, such as allyl acetate and allyl benzoate, (meth)acrylamides, such as N-methyl methacrylamide and N-phenyl methacrylamide, and unsaturated nitriles, such as acrylonitrile and methacrylonitrile. Particularly preferred monomers include alkyl (meth)acrylates, vinyl chloride, vinyl acetate and styrene.

Preferred prepolymers, i.e. polymers of low molecular weight that have been obtained in a separate polymerization reaction, include, but are not restricted to, polyesters, polyethers, polyamides, polycarbonates and polyurethanes. Particularly preferred are aromatic and aliphatic polyurethanes.

The one or more acrylic resins may be obtained by random copolymerization (i.e. the monomers are dispersed in a water emulsion and copolymerized in the presence of an initiator) or, preferably, they may be manufactured as structured copolymers, wherein the one or more monomers and/or prepolymers are added in subsequent polymerization steps. Usually, structured copolymers are defined either as block copolymers, in which A-B or A-B-A arrangements are respected, wherein A and B stand for an homogenous sequence of the same monomer or prepolymer, or graft copolymers, in which sequences of one monomer or prepolymer are distributed along a linear arrangement of the other monomer or prepolymer.

Preferably, the one or more acrylic resins are water dispersible, i.e. they are dispersed in the aqueous phase as a stable emulsion (polymeric droplets) or as a stable dispersion (polymeric beads), depending on the T_{g} value of the acrylic resin. Said beads or droplets have a particle size of between about 50 nm and about 1 μm, preferably of between about 70 nm and about 300 nm, as determined using a Brookhaven Model BI-90 particle sizer (Brookhaven Instruments Corp, Holtsville USA). This gives them a characteristic translucent or milky appearance.

The molecular weight of the one or more acrylic resins is preferably between about 10′000 and 1′000′000 Daltons and more preferably between about 50′000 and 500′000 Daltons.

In a particular embodiment, the one or more acrylic resins are self-crosslinking resins. Self-crosslinking polymers further comprise one or more functional groups which are self-reactive. The crosslinking reaction usually takes place when water is removed upon drying or when the temperature is raised beyond a given threshold. Particular self-crosslinking acrylic resins are made of core-shell particles, wherein the hydrophobic (e.g. polystyrene) core includes the one or more self-crosslinking functional groups and the hydrophilic shell comprises the (meth)acrylic acid groups, thus stabilizing the dispersion.

Upon drying (in general using accelerating means such as hot air ovens or IR driers), water progressively evaporates and the beads or droplets of the one or more acrylic resins coalesce to form a film in which the IR-absorbing material is stabilized. The minimum temperature at which the film can form is called minimum film forming temperature (MFFT) and is preferably close to or slightly higher than the room temperature, so that the polymeric film forms when the coated substrate passes through the drying devices. Since the one or more acrylic resins are able to stabilize the IR-absorbing material in a very effective way, the ratio between the dry amount of the one or more acrylic resins and the amount of the IR-absorbing pigment is low, preferably between about 50:50 and about 75:25 and more preferably between about 60:40 and about 70:30. Accordingly, the security inks described herein may be printed as rather thin layers (typical dry layer thickness of about 3 μm to about 10 μm) while exhibiting strong absorbance in the IR domain. Furthermore, the obtained layers generally exhibit low gloss and closely mimic the inherently matte appearance of porous substrates such as fiduciary cotton paper, making them (as desired) more difficult to detect with the naked eye.

Particularly suitable aqueous acrylic compositions are commercially sold by DSM Neoresins under the designation Neocryl® XK-98 (self-crosslinking resin), Neocryl® XK-16 (self-crosslinking resin), Neocryl® XK-237 (self-crosslinking resin), Neocryl® BT-100, Neocryl® BT-20, by BASF under the designation Joncryl® 538, Joncryl® 1532, Joncryl® 1907, Joncryl® 1908 and Joncryl® 1984 (self-crosslinking resin), which consist of emulsions/dispersions comprising anionic acrylic copolymers, by Covestro under the designation NeoPac™ E-180, which consist of an emulsion comprising an aromatic urethane acrylic copolymer, by Covestro under the designation NeoPac™ E-200, which consist of an emulsion comprising an aliphatic urethane acrylic copolymer and by Worlee under the designation Zinpol 350 and Zinpol 460 which consist of dispersion/emulsion comprising a styrenic acrylic copolymer.

At the pH required to ensure sufficient stability of the security inks described herein (i.e. between about 7.0 and about 9.0), the (meth)acrylic groups of the one or more acrylic resins are stabilized as acrylates by one or more neutralizing agents. Said neutralizing agents may be inorganic bases, organic bases or any combinations thereof. Examples of inorganic bases include but are not limited to the alkali metal hydroxides (especially lithium, sodium, potassium, magnesium), alkali metal carbonates, alkali metal hydrogen carbonates and alkali metal salts of inorganic acids, such as sodium borate (borax), sodium phosphate, sodium pyrophosphate, ammonia and mixtures thereof. Preferred inorganic base is ammonia, since it is relatively unexpensive and its ready evaporation favors quick drying. Preferred organic bases are amines, such as triethanolamine, triethylamine, dimethyl isopropyl amine, N-methyl ethanolamine, N-methyl diethanolamine, N,N′-dimethyl ethanolamine and 2-amino-2-methyl-1-propanol.

In addition to the one or more acrylic resins described herein, the binder described herein may comprise up to 30 wt-%, preferably up to 25 wt-% and more preferably up to 20 wt-%, of one or more additional resins different from said acrylic resins, the weight percent being based on the total weight of the binder; in other words, a portion of the acrylic resins may be replaced by one or more additional resins. The one or more resins described herein are water-soluble or water-dispersible resins, preferably water-dispersible resin, that may be selected from the group consisting of polyurethanes, polyvinyl alcohols, polyamides and polyolefins. According to one embodiment, said one or more additional resins are polyurethanes. As known by the man skilled in the art, the use of polyurethane resins improves the physical and chemical resistance of security features obtained from said inks and enhance their flexibility and adhesion to substrates in particular to polymeric and plastic substrates. Should one or more polyurethane resins be used in combination with the acrylic resins described herein in the binder described herein, said binder is required to comprise up to 30 wt-%, preferably up to 25 wt-% and more preferably up to 20 wt-% of said polyurethane resins, higher amounts negatively impacting the stability of the ink upon storage due to a progressive increase of viscosity.

The security inks described herein comprise from about 0.125 wt-% to about 5.0 wt-% of the one or more zinc aluminum phosphate compounds, the weight percents being based on the total weight of the security ink, wherein the ratio R between the amount of the one or more zinc aluminum phosphate compounds versus the sum of the amount of the one or more zinc aluminum phosphate compounds and the one or more IR absorbing materials (ratio R=m (the one or more zinc aluminum phosphate compounds)/[m (the one or more zinc aluminum phosphate compounds)+m (one or more the one or more IR absorbing materials)] is between about 2.0 and about 20, preferably between about 2.5 and 20 and more preferably between about 2.5 and 10.

Preferably, each of said one or more zinc aluminum phosphate compounds is an orthophosphate such as for example zinc aluminum orthophosphate or a polyphosphate such as zinc aluminum polyphosphate including their hydrates. Preferably each of the one or more zinc aluminum phosphate compounds is a zinc aluminum phosphate hydrate, preferably orthophosphate or polyphosphate, hydrate compound. The one or more zinc aluminum phosphate compounds may further comprise molybdenum, calcium and/or strontium and/or silicon.

The one or more zinc aluminum phosphate compounds described herein independently preferably comprise from about 20 wt-% to about 70 wt-% of zinc, more preferably from about 25 wt-% to about 65 wt-% of zinc (said wt-% being calculated from the wt-% of ZnO in the compounds, said wt-% being measured according to ISO 6745); and from about 0.5 wt-% to about 20 wt-% of aluminum, more preferably from about 1 wt-% to about 15 wt-% of aluminum (said wt-% being calculated from the wt-% of Al₂O₃ in the compounds, said wt-% being measured by ICP); and from about 10 wt-% to about 70 wt-% of phosphorus, more preferably from about 15 wt-% to about 60 wt-% of phosphorus (P) (said wt-% being calculated from the wt-% of PO₄³⁻ or P₂O₅ in the compounds, said wt-% being measured according to ISO 6745); the weight percents being based on the total weights of said zinc aluminum phosphate compounds.

Calculated as the weight percent of each element (as Zn, Al and P), the one or more zinc aluminum phosphate compounds described herein independently preferably comprise from about 15 wt-% to about 60 wt-%, more preferably from about 20 wt-% to about 55 wt-% of zinc (Zn); from about 0.3 wt-% to about 12 wt-%, more preferably from about 0.5 wt-% to about 8 wt-% of aluminum (Al); and from about 5 wt-% to about 30 wt-%, more preferably from about 6 wt-% to about 25 wt-% of phosphorus (P); the weight percents being based on the total weights of said zinc aluminum phosphate compounds.

Preferably, the one or more zinc aluminum phosphate compounds have a particle size between about 0.5 microns and about 10 microns, more preferably between about 1 microns and about 5 microns.

Suitable zinc aluminum phosphate compounds are commercially sold by Heubach under the designation HEUCOPHOS® ZAM-Plus (organic modified zinc aluminum molybdenum orthophosphate hydrate), HEUCOPHOS® ZCP-Plus (zinc calcium strontium aluminum orthophosphate silicate hydrate), HEUCOPHOS® ZAPP (zinc aluminum polyphosphate hydrate) and HEUCOPHOS® ZPA (zinc aluminum orthophosphate hydrate).

The security inks described herein may further comprise one or more additives selected from fillers, waxes, surfactants, anti-foaming agents, thickening agents and mixtures thereof.

The security inks described herein may further comprise one or more fillers provided that these potential additional fillers or extenders do not negatively interfere with the absorption properties in the IR/NIR range spectrum of interest of the machine readable security features and do not negatively interfere with their optical properties. The one or more one or more fillers described herein are preferably selected from the group consisting of carbon fibers, talcs, mica (muscovite), wollastonites, calcinated clays, China clays, kaolins, carbonates (e.g. calcium carbonate, sodium aluminum carbonate), silicas and silicates (e.g. magnesium silicate, aluminum silicate), sulfates (e.g. magnesium sulfate, barium sulfate), titanates (e.g. potassium titanate), alumina hydrates, silica, fumed silica, montmorillonites, graphites, anatases, rutiles, bentonites, vermiculites, zinc whites, zinc sulfides, wood flours, quartz flours, natural fibers, synthetic fibers and combinations thereof. Alternatively, and with the aim of not compromising the optical properties of the machine readable security feature described herein, microspheres or hollow spheres made of polymer (e.g. polystyrene or PMMA) or made of glass may be used as the one or more fillers. When present, the one or more fillers are preferably present in an amount from about 0.01 to about 10 wt-%, preferably from about 0.1 to about 5 wt-% the weight percents being based on the total weight of the security ink.

The security inks described herein may further comprise one or more waxes preferably selected from the group consisting of synthetic waxes, petroleum waxes and natural waxes. Preferably the one or more waxes are selected from the group consisting of microcrystalline waxes, paraffin waxes, polyethylene waxes, polyamide waxes, fluorocarbon waxes, polytetrafluoroethylene waxes, micronized PTFE-modified polyethylene waxes, Fischer-Tropsch waxes, silicone fluids, beeswaxes, candelilla waxes, montan waxes, carnauba waxes and mixtures thereof. When present, the one or more waxes are preferably present in an amount from about 0.1 to about 3 wt-%, the weight percents being based on the total weight of the security ink.

The security inks described herein may further comprise one or more thickening agents to adjust the rheological properties of the security inks described herein. Natural thickening agents include without limitation xanthan gums, alginic acids and salts thereof (in particular sodium alginate), guar gums, locust bean gums, agar, carboxymethyl celluloses, hydroxyethyl celluloses, pectins, caseins, gelatins and carrageenans. Synthetic thickening agents include without limitation hydrophobically ethoxylated urethane resins (HEURS), hydrophobically modified polyethers (HMPEs), alkali swellable emulsions (ASEs), hydrophobically modified alkali swellable emulsions (HASEs), polyacrylamides, polyethylene oxides, polyvinylpyrrolidones, polyvinylmethylether and polyether polyol compounds. Suitable thickening agents are commercially sold by Elementis under the designation RHEOLATE® 212, RHEOLATE® 255, RHEOLATE® 278 TF, RHEOLATE® HX 6008 and RHEOLATE® HX 6010, by BYK under the designation RHEOBYK®-T 1000 VF, RHEOBYK®-T 1010 VF, RHEOBYK®-L 1400 VF, RHEOBYK®-HV 80, RHEOBYK®-M 2600 VF, by BASF under the designation RHEOVIS® AS 1130, RHEOVIS® PU 1190, RHEOVIS® PU 1214, RHEOVIS® PU 1291, RHEOVIS® PU 1331, RHEOVIS® PU 1341, RHEOVIS® PE 1330 and RHEOVIS® PE 1331, and by Tiarco Chemicals under the designation Paragum 500, Paragum 530 and Paragum 600. When present, the one or more thickening agents are preferably present in an amount from about 0.05 to about 5 wt-%, more preferably in an amount from about 0.1 to about 3 wt-%, the weight percents being based on the total weight of the security ink.

The security inks described herein may further comprise one or more iridescent pigments. Typical examples of iridescent pigments include without limitation interference coated pigments consisting of a core made of synthetic or natural micas, other layered silicates (e.g. talc, kaolin and sericite), glasses (e.g. borosilicates), silicon dioxides (SiO₂), aluminum oxides (Al₂O₃), aluminum oxides/hydroxides (boehmite), and mixtures thereof coated with one or more layers made of metal oxides (e.g. titanium oxide, zirconium oxide, tin oxide, chromium oxide, nickel oxide, copper oxide, iron oxide and iron oxide/hydroxide). The structures described hereabove have been described for example in Chem. Rev. 99 (1999), G. Pfaff and P. Reynders, pages 1963-1981 and WO 2008/083894 A2. Typical examples of these interference coated pigments include without limitation silicon oxide cores coated with one or more layers made of titanium oxide, tin oxide and/or iron oxide; natural or synthetic mica cores coated with one or more layers made of titanium oxide, silicon oxide and/or iron oxide, in particular mica cores coated with alternate layers made of silicon oxide and titanium oxide; borosilicate cores coated with one or more layers made of titanium oxide, silicon oxide and/or tin oxide; and titanium oxide cores coated with one or more layers made of iron oxide, iron oxide/hydroxide, chromium oxide, copper oxide, cerium oxide, aluminum oxide, silicon oxide, bismuth vanadate, nickel titanate, cobalt titanate and/or antimony-doped, fluorine-doped or indium-doped tin oxide; aluminum oxide cores coated with one or more layers made of titanium oxide and/or iron oxide.

The security inks described herein may comprise one or more further IR-absorbers known in the art. The role of said further IR-absorbers may be to slightly modify the reflectance profile of the machine readable security feature such as to fully conform to the specifications of the detection system.

Said one or more further IR-absorbers may be selected from the group consisting of a) compounds comprising one or more transition elements selected from the group consisting of Ti, V, Cr, Mn, Fe, Co, and Ni and one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates, silicates (SiO₄⁴⁻), condensed polysilicates; titanates (TiO₃²⁻), condensed polytitanates, vanadates (VO₄³⁻), condensed polyvanadates, molybdates (MoO₄²⁻), condensed molybdates, tungstates (WO₄²⁻), condensed polytungstates, niobates (NbO₃²⁻), fluorides (F⁻), chlorides (Cl⁻), sulfates (SO₄²⁻) and/or hydroxides (OH); b) inorganic compounds selected from the group consisting of doped tin oxides, doped indium oxides, reduced tungsten oxides, tungsten bronzes; c) organic compounds selected from the group consisting of phthalocyanine compounds, naphthalocyanine compounds, dithiolene compounds, rylene-based compounds; and d) mixtures thereof. When present, the amount of the one or more further IR-absorbers is preferably from about 0.5 wt-% to about 25 wt-%, the weight percents being based on the total weight of the security ink. The ratio between the one or more further IR-absorbers, when present, and the total of all IR-absorbers is preferably between about 0.1 wt-% and about 30 wt-%, and more preferably between about 1 wt-% and about 15 wt-%.

According to one embodiment, at least one of the one or more further IR-absorbers is doped tin oxide, wherein tin oxide is preferably doped with antimony (antimony tin oxide, ATO), wherein the antimony is present in an amount from about 0.5 to about 20 mol-%, preferably from about 2 to about 18 mol-%.

According to another embodiment, at least one of the one or more further IR-absorbers is doped indium oxide, wherein indium oxide is preferably doped with tin (indium tin oxide, ITO), wherein the tin is present in an amount from about 1 to about 30 mol-%, preferably from about 5 to about 15 mol-%. Preferably, reduced indium tin oxide is used as the one or more further IR-absorbers. The level of reduction is preferably between about 0.1 mol-% and about 5 mol-%, more preferably between about 0.5 mol-% and about 1 mol-%, wherein a level of reduction of 1 mol-% means that an oxygen atom has been removed from 1% of the indium tin oxide units.

According to another embodiment, at least one of the one or more further IR-absorbers is reduced tungsten oxide and/or one of the one or more further IR-absorbers is tungsten bronze. Reduced tungsten oxides are non-stoichiometric compounds of the general formula W_{y}O_{z} wherein the ratio z/y is smaller than 3 and greater than 2, preferably smaller than 2.99 and greater than 2.2, more preferably smaller than 2.9 and greater than 2.7. Such compounds are described for example in H. Takeda and K. Adachi, J. Am Ceram. Soc., 90 [12], 2007, p. 4059-4061, in US 2006/0178254 and US 2007/0187653.

Tungsten bronzes are non-stoichiometric compounds obtained from the stoichiometric tungsten oxide WO₃ or tungstates MWO₄. Tungsten bronzes of formula MₓW_{y}O_{z} are described for example in US 2006/0178254 and US 2007/0187653, wherein US 2006/0178254 discloses MₓW_{y}O_{z} whereby 0.001≤x/y≤1 and 2.2≤z/y≤3.0 and US 2007/0187653 discloses MₓW_{y}O_{z} whereby 0.001≤x/y≤1.1 and 2.2≤z/y≤3.0 and M is at least one element selected from the group consisting of H, He, alkali metals, alkaline earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi and I, preferably Na, Cs, Rb, K, Tl, In, Ba, Li, Ca, Sr, Fe and Sn.

Tungsten bronzes of formula MₓWO₃ are described for example in US 2006/0178254 and US 2007/0187653, wherein M is a metal element, such as an alkali metal, alkaline earth metal or rare earth metal and whereby 0<x<1. Such compounds, wherein M=K are also described in C. Guo et al, ACS Appl. Mater. Interfaces, 3, 2011, p. 2794-2799 and are shown to display a strong absorption beyond 900 nm.

Tungsten bronzes of formula M_{E}A_{G}W_{(1-G)}O_{J} are described for example in US 2007/0187653, where M is one or more elements selected from H, He, alkali metals, alkaline-earth metals, rare earth elements, Mg, Zr, Cr, Mn, Fe, Ru, Co, Rh, Ir, Ni, Pd, Pt, Cu, Ag, Au, Zn, Cd, Al, Ga, In, Tl, Si, Ge, Sn, Pb, Sb, B, F, P, S, Se, Br, Te, Ti, Nb, V, Mo, Ta, Re, Be, Hf, Os, Bi, and I; A is one or more elements selected from Mo, Nb, Ta, Mn, V, Re, Pt, Pd, and Ti; W is tungsten; O is oxygen; and 0<E≤1.2; 0<G≤1; and 2≤J≤3.

US 2011/0248225 discloses for example potassium cesium tungsten bronze solid solutions of the formula KₓCs_{y}WO_{z} where x+y≤1 and 2≤z≤3. Such compounds are shown to be strong absorbers in the range 1200-1750 nm.

Suitable examples of phthalocyanine compounds and naphthalocyanine compounds are disclosed in EP 0 799 831 B1 and EP 3 140 352 B. Suitable examples of dithiolene compounds are disclosed in EP 2 101 986 B. Suitable examples of rylene-based compounds are disclosed in WO 2010/112452 A1, EP 1 879 847 B and EP 1 874 773 B.

The security inks described herein may further comprise one or more luminescent compounds, such as to provide a security feature with enhanced counterfeiting resistance.

The security ink described herein described herein may further comprise one or more marker substances or taggants.

The security ink described herein may further comprise one or more additives, said one or more additives including without limitation compounds and materials which are used for adjusting physical, rheological and chemical parameters of the security ink such as the consistency (e.g. anti-settling agents and plasticizers), the foaming properties (e.g. antifoaming agents and deaerators), the lubricating properties (waxes), the UV stability (photostabilizers), the adhesion properties, the surface properties (wetting agents, oleophobic and hydrophobic agents), etc. Additives described herein may be present in the security inks described herein in amounts and in forms known in the art, including in the form of so-called nano-materials where at least one of the dimensions of the additives is in the range of 1 to 1000 nm.

The security ink described herein may further comprise one or more crosslinking agents. to further enhance the mechanical resistance of the machine readable security feature obtained thereof. Said crosslinking agents bear functional groups that are able to react with carbonyl groups of the one or more acrylic resins and reinforce the polymeric network. Usually, the reaction starts when thermal treatment (such as hot air or IR driers) is applied to the security features. Examples of crosslinking agents include without limitation organic chelates of titanium or zirconium, polycarbodiimide compounds (e.g. CX-300 sold by DSM NeoResins), polyaziridine compounds (e.g. CX-100 sold by DSM NeoResins), polyoxazoline compounds, amino resins (e.g. melamine-formaldehyde), blocked isocyanates, silane compounds, polyglycidylether compounds and epoxysiloxane compounds (e.g. CoatOSil™ 1770 sold by Momentive Performance Materials and Dynasylan® GLYMO sold by Evonik Industries).

The present invention further provides methods for producing the security inks described herein and security inks obtained therefrom.

The security inks described herein may be prepared by:
i) mixing and/or dispersing the one or more zinc aluminum phosphate compounds in water at room temperature;
ii) subsequently to step i), mixing and/or dispersing the mixture obtained in step i) with the one or more IR absorbing materials, preferably at room temperature, so as to form a dispersion, and
iii) filtrating and drying, preferably 24 hours at a temperature of at least 50° C., the dispersion obtained in step ii) so as to get said surface treated IR absorbing materials as a solid powder;
iii) subsequently to step ii), mixing and/or dispersing the solid powder obtained in step iii) with a mixture comprising the water, the binder comprising the one or more acrylic resins and the optional additives, preferably at room temperature.

The security inks described herein may be prepared by:
i) mixing and/or dispersing the one or more IR absorbing materials described herein and the one or more zinc aluminum phosphate compounds in water, preferably at room temperature, so as to produce IR absorbing materials surface treated with said one or more zinc aluminum phosphate compounds;
ii) subsequently to step i), filtrating and drying, preferably 24 hours at a temperature of at least 50° C., the dispersion obtained in step i) so as to get said surface treated IR absorbing materials as a solid powder;
iii) subsequently to step ii), mixing and/or dispersing the solid powder obtained in step ii) with a mixture comprising the water, the binder comprising the one or more acrylic resins and the optional additives, preferably at room temperature.

Alternatively, the security inks described herein may be prepared by:
i) mixing the one or more IR absorbing materials with the one or more zinc aluminum phosphate compounds so as to produce a solid powder of intimately mixed compounds,
ii) mixing and/or dispersing the powder obtained in step i) with the binder comprising one or more acrylic resins, preferably at room temperature, so as to form a dispersion, and
iii) subsequently to step ii), mixing and/or dispersing the dispersion obtained in step ii) with water and the optional additives, preferably at room temperature.

Alternatively, the security inks described herein may be prepared by:
i) mixing and/or dispersing the one or more zinc aluminum phosphate compounds and the binder comprising the one or more acrylic resins, preferably at room temperature, so as to form a dispersion,
ii) subsequently to step i), mixing and/or dispersing the dispersion obtained in step i) with the one or more IR absorbing materials, preferably at room temperature, and
iii) subsequently to step ii), mixing and/or dispersing the dispersion obtained in step ii) with water and the optional additives, preferably at room temperature.

Alternatively, the security inks described herein may be prepared by:
i) mixing and/or dispersing the one or more zinc aluminum phosphate compounds in water, preferably at room temperature,
ii) subsequently to step i), mixing and/or dispersing the dispersion obtained in step i) with the one or more IR absorbing materials, preferably at room temperature,
iii) subsequently to step ii), filtrating and drying, preferably 24 hours at a temperature of at least 50° C., the dispersion obtained in step ii) so as to get said surface treated IR absorbing materials as a solid powder;
iv) subsequently to step iii), mixing and/or dispersing the solid powder obtained in step iii) with the binder comprising the one or more acrylic resins, preferably at room temperature, as to obtain a dispersion, and
iv) subsequently to step iv), mixing and/or dispersing the dispersion obtained in step iv) with water and the optional additives, preferably at room temperature.

The security inks described herein are applied on the substrate described herein for producing a machine readable security feature preferably by a screen printing process described herein.

Screen printing (also referred in the art as silkscreen printing) is a printing technique that typically uses a screen made of woven mesh to support an ink-blocking stencil. The attached stencil forms open areas of mesh that transfer ink as a sharp-edged image onto a substrate. A squeegee is moved across the screen with ink-blocking stencil, forcing ink past the threads of the woven mesh in the open areas. Generally, a screen is made of a piece of porous, finely woven fabric called mesh stretched over a frame of e.g. aluminum or wood. Currently most meshes are made of man-made materials such as synthetic or steel threads. Preferred synthetic materials are nylon or polyester threads.

In addition to screens made on the basis of a woven mesh based on synthetic or metal threads, screens have been developed out of a solid metal sheet with a grid of holes. Such screens are prepared by a process comprising of electrolytically forming a metal screen by forming in a first electrolytic bath a screen skeleton upon a matrix provided with a separating agent, stripping the formed screen skeleton from the matrix and subjecting the screen skeleton to an electrolysis in a second electrolytic bath in order to deposit metal onto said skeleton.

There are three types of screen printing presses, namely flat-bed, cylinder and rotary screen printing presses. Flat-bed and cylinder screen printing presses are similar in that both use a flat screen and a three-step reciprocating process to perform the printing operation. The screen is first moved into position over the substrate, the squeegee is then pressed against the mesh and drawn over the image area, and then the screen is lifted away from the substrate to complete the process. With a flat-bed press the substrate to be printed is typically positioned on a horizontal print bed that is parallel to the screen. With a cylinder press the substrate is mounted on a cylinder. Flat-bed and cylinder screen printing processes are discontinuous processes, and consequently limited in speed which is generally at maximum 45 m/min in web or 3′000 sheets/hour in a sheet-fed process.

Conversely, rotary screen presses are designed for continuous, high speed printing. The screens used on rotary screen presses are for instance thin metal cylinders that are usually obtained using the electroforming method described hereabove or made of woven steel threads. The open-ended cylinders are capped at both ends and fitted into blocks at the side of the press. During printing, ink is pumped into one end of the cylinder so that a fresh supply is constantly maintained. The squeegee is fixed inside the rotating screen and squeegee pressure is maintained and adjusted to allow a good and constant print quality. The advantage of rotary screen presses is the speed which can easily reach 150 m/min in web or 10′000 sheets/hour in a sheet-fed process.

Screen printing is further described for example in The Printing Ink Manual, R. H. Leach and R. J. Pierce, Springer Edition, 5^{th} Edition, pages 58-62, in Printing Technology, J. M. Adams and P. A. Dolin, Delmar Thomson Learning, 5^{th} Edition, pages 293-328 and in Handbook of Print Media, H. Kipphan, Springer, pages 409-422 and pages 498-499.

The present invention further provides methods for producing the machine readable security features described herein and machine readable security features obtained thereof. The method comprises a step a) of applying, preferably by a printing processed selected form the group consisting of gravure printing, flexography printing and screen printing, more preferably by screen printing as described herein, the security ink described herein onto the substrate described herein. After having carried out the printing step, a step b) of drying the security ink in the presence of hot air, infrared or by a combination thereof is carried out so as to form the machine readable security feature described herein on the substrate, said step of drying being performed after the step a). Preferably, the step b) of drying the security ink described herein is carried out between about 30 seconds and about 2 minutes, preferably at a temperature between about 20° C. (room temperature) and about 70° C. The time between the step a) (i.e. step a) of screen printing) and the step b) (i.e. step b) of drying) is preferably between about 0.1 sec and about 10 sec, more preferably between about 0.1 sec and about 5 sec and even more preferably between about 0.5 sec and about 2 sec.

The present invention further provides machine readable security features made of the security ink described herein on the substrate described herein.

The machine readable security features comprising the one or more IR absorbing materials described herein may consist of an indicium, wherein indicia” shall mean discontinuous layers such as patterns, including without limitation symbols, alphanumeric symbols, motifs, letters, words, numbers, logos and drawings. Preferably, the indicium is selected from the group consisting of codes, symbols, alphanumeric symbols, motifs, geometric patterns (e.g. circles, triangles and regular or irregular polygons), letters, words, numbers, logos, drawings, portraits and combinations thereof. Examples of codes include encoded marks such as an encoded alphanumeric data, a one-dimensional barcode, a two-dimensional barcode, a QR-code, and a datamatrix.

According to one embodiment, the substrates described herein are preferably selected from the group consisting of papers or other fibrous materials (including woven and non-woven fibrous materials), such as cellulose, paper-containing materials. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. As well known by the man skilled in the art, the substrate can comprise further additives that are known to the skilled person, such as fillers, sizing agents, whiteners, processing aids, reinforcing or wet strengthening agents, etc. According to another embodiment, the substrates described herein are preferably made of plastics and polymers materials including for example polyethylenes (PE), polypropylenes (PP, such as for example oriented polypropylene (OPP, uniaxially stretched in the transverse direction), biaxially oriented polypropylene (BOPP, stretched in machine direction and transverse direction) and monoaxially oriented polypropylene (MOPP, uniaxially stretched in the machine direction)), polyamides (PA), polyesters such as poly(ethylene terephthalate) (PET), polyethylene terephthalate glycol-modified (PETG) including poly(ethylene glycol-co-1,4-cyclohexanedimethanol terephthalate), poly(1,4-butylene terephthalate) (PBT), poly(ethylene 2,6-naphthoate) (PEN) and polyvinylchlorides (PVC). When the substrates are made of plastics and polymers materials, one or more opacifying layers may be present on their surfaces.

The machine readable security features described herein advantageously exhibit high reflectance in the visible range and low reflectance in the infrared or near-infrared range, thus allowing an efficient authentication and recognition by a standard equipment and standard detectors including those featuring high-speed banknote sorting machines, since such detectors rely on the reflectance difference at selected wavelengths in the Vis and the IR ranges. In particular, the security inks described herein allow the production of colorless or slightly colored machine readable security features, i.e. machine readable security features having the following optical properties: a lightness L* equal to or higher than about 80 (preferably equal to or higher than about 85 and more preferably equal to or higher than about 90), a a* value higher than about-3.0 (preferably higher than about-2.7 and even more preferably higher than about-2.5), a b* value lower than about 8.5 (preferably lower than about 7.5 and even more preferably lower than about 6.5) and a reflectance at 900 nm smaller than or equal to about 60% (preferably smaller than or equal to about 55% and more preferably smaller than or equal to about 45%). As described herein, the L*, a* and b* values of said machine readable security features are measured according to CIELAB (1976), a* and b* being the color coordinates in a Cartesian 2-dimensional space (a*=color value along the red/green axis and b*=color value along the blue/yellow axis), wherein L*a*b* values are independently obtained with a spectrophotometer DC 45IR from Datacolor (measurement geometry: 45/0°; spectral analyzer: proprietary dual channel holographic grating. 256-photodiode linear arrays used for both reference and sample channels; light source: total bandwidth LED illumination). The substrate must have a higher IR reflectance than the machine readable security feature in order not to affect the measured values (this is true for most of non-colored security substrates).

As described herein, reflectance at 900 nm of the machine readable security features described herein may be measured with a spectrophotometer DC45IR from Datacolor, wherein 100% reflectance is measured using the internal standard of the device.

Security documents, in particular banknotes, are produced using sequential printing processes involving different printing technologies. In particular, a banknote substrate is subjected to a number of different types of printing processes in series, each one being completed before the next step is applied, requiring significant overhead in terms of handling and storage. The colorless or slightly colored machine readable security features described herein advantageously may be integrated in and/or on security documents and allow a freedom in terms of design for subsequent security printing steps. For example, the security ink described herein may be applied by the substrate manufacturer as a first step of the known security document multi printing steps so as to form colorless or slightly colored machine readable security features preferably having the shape of one or more indicia as described herein. Subsequently, security printers may produce for example by an offset and intaglio printing processes one or more additional security features, said features partially or fully covering the machine readable security features described herein. Preferably, said additional security features are prepared from IR-transparent inks, i.e. inks exhibiting a low reflectance in some parts of the visible spectrum and high reflectance in the near IR domain, as shown in the sole FIGURE.

With the aim of further increasing the security level and the resistance against counterfeiting and illegal reproduction of security documents, the substrate described herein may contain printed, coated, or laser-marked or laser-perforated indicia, watermarks, security threads, fibers, planchettes, luminescent compounds, windows, foils, decals, primers and combinations of two or more thereof, provided that these potential additional features or elements do not negatively interfere with the absorption properties in the IR/NIR range spectrum of interest of the machine readable security feature and do not negatively interfere with optical properties described herein of the machine readable security feature described herein.

With the aim of increasing the durability through soiling or chemical resistance and cleanliness and thus the circulation lifetime of security documents or with the aim of modifying their aesthetical appearance (e.g. optical gloss), one or more protective layers may be applied on top of the machine readable security features or security document described herein. When present, the one or more protective layers are typically made of protective varnishes which may be transparent or slightly colored or tinted and may be more or less glossy. Protective varnishes may be radiation curable compositions, thermal drying compositions or any combination thereof. Preferably, the one or more protective layers are made of radiation curable compositions, and more preferably of UV-Vis curable compositions.

The machine readable security features described herein may be provided directly on a substrate on which it shall remain permanently (such as for banknote applications). In some cases, the machine readable security features described herein may be produced on an auxiliary substrate such as for example for example a security thread, a security stripe, a foil, a decal, a window or a label and consequently transferred to a security document in a separate step. Alternatively, a machine readable security feature may also be provided on a temporary substrate for production purposes, from which the machine readable security feature is subsequently removed. Thereafter, after hardening/curing of the security ink described herein for the production of the machine readable security feature, the temporary substrate may be removed from the machine readable security feature.

Alternatively, in another embodiment an adhesive layer may be present on machine readable security feature or may be present on the substrate comprising the machine readable security feature described herein, said adhesive layer being on the side of the substrate opposite to the side where the machine readable security feature is provided or on the same side as the machine readable security feature and on top of the machine readable security feature. Therefore, an adhesive layer may be applied to the machine readable security feature or to the substrate, said adhesive layer being applied after the drying or curing step has been completed. Such an article may be attached to all kinds of documents or other articles or items without printing or other processes involving machinery and rather high effort. Alternatively, the substrate described herein comprising the machine readable security feature described herein may be in the form of a transfer foil, which can be applied to a document or to an article in a separate transfer step. For this purpose, the substrate is provided with a release coating, on which the machine readable security feature is produced as described herein. One or more adhesive layers may be applied over the so produced machine readable security feature.

Also described herein are substrates, security documents, decorative elements and objects comprising more than one, i.e. two, three, four, etc. machine readable security feature described herein. Also described herein are articles, in particular security documents, decorative elements or objects, comprising the machine readable security feature described herein.

As mentioned hereabove, the machine readable security features described herein may be used for protecting and authenticating a security document or decorative elements.

Security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets, academic diploma or titles and the like, preferably banknotes, identity documents, right-conferring documents, driving licenses and credit cards. The term “value commercial good” refers to packaging materials, in particular for cosmetic articles, nutraceutical articles, pharmaceutical articles, alcohols, tobacco articles, beverages or foodstuffs, electrical/electronic articles, spare parts (e.g. for automotive, aeronautical or electronic applications), fabrics or jewelry, i.e. articles that shall be protected against counterfeiting and/or illegal reproduction in order to warrant the content of the packaging like for instance genuine drugs or spare parts. Examples of these packaging materials include without limitation labels, such as authentication brand labels, tamper evidence labels and seals. It is pointed out that the disclosed substrates, value documents and value commercial goods are given exclusively for exemplifying purposes, without restricting the scope of the invention.

The present invention further provides methods for authenticating a security document comprising the steps of a) providing the security document described herein and comprising the machine readable security feature made of the security ink recited described herein; b) illuminating the machine readable security feature at at least one wavelength in the IR range (preferably between 780 nm and 3000 nm, more preferably between 780 nm and 1600 nm and still more preferably between 800 nm and 1200 nm), c) detecting the optical characteristics of the machine readable security feature through sensing of light reflected by and/or transmitted through said machine readable security feature at at least one wavelength, wherein said at least one wavelengths is in the in the IR range (preferably between 780 nm and 3000 nm, more preferably between 780 nm and 1600 nm and still more preferably between 800 nm and 1200 nm); and d) determining the security document authenticity from the detected optical characteristics of the machine readable security feature. The present inventions also provides methods for authenticating a security document comprising the steps of a) providing the security document described herein and comprising the machine readable security feature made of the security ink recited described herein; b) illuminating the machine readable security feature at at least two wavelengths, wherein one of said at least two wavelengths is in the visible range (400-700 nm) and another one of said at least two wavelengths is in the IR range (preferably between 780 nm and 3000 nm, more preferably between 780 nm and 1600 nm and still more preferably between 800 and 1200 nm), c) detecting the optical characteristics of the machine readable security feature through sensing of light reflected by and/or transmitted through said machine readable security feature at at least two wavelengths, wherein one of said at least two wavelengths is in the visible range and another one of said at least two wavelengths is in the IR range (preferably between 780 nm and 3000 nm, more preferably between 780 nm and 1600 nm and still more preferably between 800 nm and 1200 nm); and d) determining the security document authenticity from the detected optical characteristics of the machine readable security feature.

The authentication of the machine readable security features described herein and made of the security inks described herein may be performed by using an authenticating device comprising one or more light sources, one or more detectors, an analog-to-digital converter and a processor. The machine readable security feature is, simultaneously or subsequently, illuminated by the one or more light sources; the one or more detectors detect the light reflected by or transmitted through said machine readable security feature and output an electrical signal proportional to the light intensity; and the analog-to-digital converter converts said signals into a digital information that is compared by the processor to a reference stored in a database. The authenticating device then outputs a positive signal of authenticity (i.e. the machine readable security feature is genuine) or a negative signal (i.e. the machine readable security feature is fake).

According to one embodiment, the authenticating device comprises a first source (such as a VIS LED) emitting at a first wavelength in the visible range, a second source (such as an IR LED) emitting at a second wavelength in the IR range and a broadband detector (such as a photomultiplier). The first and second sources emit at a time interval, allowing the broadband detector to separately output signals corresponding to the VIS and IR emissions, respectively. These two signals may be compared separately (the VIS signal with the VIS reference and the IR signal with the IR reference). Alternatively, these two signals may be converted to a difference (or ratio) value and said difference (or ratio) value may be compared to the difference (or ratio) reference stored in the database. The signals may be read in reflection and/or in transmission.

According to another embodiment of the detector unit, and with the aim of increasing the operational speed, said detector may comprise two detectors specifically matched to the emission wavelength of the first and second sources (such as a Si photodiode for the visible range and an InGaAs photodiode for the IR range). The first and second sources emit at the same time, the two detectors sense the light reflected by or transmitted through the security feature at the same time, and the two signals (or their difference or ratio) are compared to references stored in the database.

According to another embodiment, and with the aim of increasing the resistance against counterfeiting, the authenticating device comprises a source emitting at a plurality (i.e. two, three, etc.) of wavelengths in the VIS range and at a plurality (i.e. two, three, etc.) of wavelengths in the IR range. The sources are sequentially activated, and the light reflected by or transmitted through the machine readable security feature is detected by a broadband detector (such as a photomultiplier). The signals corresponding to the plurality of emission wavelengths are then processed into a complete spectrum, which is compared to a reference spectrum stored in a database.

According to another embodiment, and with the aim of increasing the resistance against counterfeiting as well as increasing the operational speed, the authenticating device comprises a broadband, continuous light source (such as a tungsten, tungsten halogen or a xenon lamp), a collimation unit, a diffraction grating and a detector array. The diffraction grating is placed in the optical path after the machine readable security feature, wherein the light reflected by or transmitted through said machine readable security feature is focused to the grating by the collimation unit (usually made of a series of lenses and/or an adjustable slit). The detector array is made of a plurality of detector elements, each of them being sensitive to a specific wavelength. In this way, signals corresponding to the light intensity at a plurality of wavelengths are simultaneously obtained, are processed as a complete spectrum and are compared to a reference spectrum in a database.

In another embodiment, and with the aim of acquiring a two-dimensional image of the machine readable security feature described herein, the detector may be a CCD or CMOS sensor. In this case, the range of detectable wavelengths is from about 400 nm to about 1100 nm (which is the upper detection limit of silicon sensors). The machine readable security feature is illuminated sequentially at at least two wavelengths, wherein one of said at least two wavelengths is in the visible range and the other one is in the IR range accessible to the CCD or CMOS detector. Alternatively, the CCD or CMOS sensor may be equipped with a filter layer, such that individual pixels of the sensor are sensitive to a different and limited region of the visible and IR spectrum. In this case, it is possible to simultaneously obtain two-dimensional images of the machine readable security feature at at least two wavelengths, one in the visible range and the other one in the IR range accessible to the CCD or CMOS detector. The two-dimensional images are then compared to reference images stored in a database.

Optionally, the authenticating device may comprise one or more light diffusing elements (like a condenser), one or more lens assemblies (like focusing or collimating lenses), one or more slits (adjustable or not), one or more reflecting elements (like mirrors, especially semi-transparent mirrors) one or more filters (such as polarizing filters) and one or more fiber optics elements.

The skilled person can envisage several modifications to the specific embodiments described above without departing from the spirit of the present invention. Such modifications are encompassed within the present invention.

Further, all documents referred to throughout this specification are hereby incorporated by reference in their entirety as set forth in full herein.

### Examples

The present invention is now described in more details with reference to non-limiting examples. The Examples below provide more details for the preparation and use of security inks for printing a machine readable security feature, said security inks independently comprising the IR absorbing material consisting of copper hydroxide phosphate Cu₂PO₄(OH) (CAS-No 12158-74-6) having a libethenite crystal structure, a particle size d50 of 2.0-2.6 μm and a particle size d98 of 7.5-12.0 μm. Laser diffractometry was used to determine the d50 and d98 values (instrument: (Cilas 1090); sample preparation: the IR absorbing material was added to distilled water, until the laser obscuration reached the operating level of 13-15%, and the measurement was performed according to the ISO norm 13320.

### A. Solvent-Based Thermal Drying Screen Printing Security Ink C0 (See Example E3 of WO2020/239740A1)

The solvent-based ink CO comprised the following ingredients:
17.6 wt-% of NeoCryl® B-728 (DSM Neoresins): Acrylic homopolymer, MW ~65000 g/mol (CAS not available)
45.3 wt-% of 2-butoxyethyl acetate (Brenntag-Schweizer, CAS No 112-07-2)
14.9 wt-% of ethyl 3-ethoxypropionate acetate (Brenntag-Schweizer, CAS No 763-69-9)
6.6 wt-% of Dowanol™ DPM (Dow Chemicals): (2-methoxymethylethoxy) propanol (CAS no 34590-94-8)
3.3 wt-% of BYK®-1752 (BYK): silicone-free defoamer (CAS not available)
0.3 wt-% of Aerosil® 200 (Evonik): silicon dioxide (CAS no7631-86-9)
12.0 wt-% of Cu₂PO₄(OH) (12158-74-6) described hereabove

All the ingredients of the solvent-based security ink CO except the IR-absorbing material Cu₂PO₄(OH) were mixed and dispersed at room temperature using a Dispermat (LC55) during 15 minutes at 1000 rpm. The IR absorbing material was then added and dispersed for 15 minutes at 1000 rpm so as to obtain the solvent-based security ink CO. The solvent-based security ink CO had a viscosity of 1200 mPas, said viscosity value being measured directly after the preparation of said ink on a 15 g sample of the solvent-based security ink CO at 25° C. with a Brookfield viscometer (model “RVDV-I Prime”, spindle 27 at 100 rpm).

30 g of the solvent-based security ink CO was placed in a 50 ml centrifuge tube (VWR® CT 50 ml) and stored in an oven (HERAEUS T6060) for 30 days at 40° C. to mimic about 4 months of aging at room temperature. Prior to its application on the substrate described hereafter, the ink was allowed to cool to room temperature.

The solvent-based security ink CO was applied by hand on a piece of fiduciary paper (BNP paper from Louisenthal, 100 g/m², 14.5 cm×17.5 cm) using a semi-automatic coater (K control coater from RK print, model 001) equipped with bar coating #3 (theoretical thickness about 24 μm), then dried with a hot air drier at a temperature of about 50° C. for about one minute, so as to form a machine readable security feature in the form of a dried coating having a thickness of 6-10 μm. The feature had a size of 10 cm×13 cm.

Optical Properties of the Security Feature Obtained from the Solvent-Based Security Ink CO

The L*, a* and b* values of the security feature obtained from the solvent-based security ink CO were obtained from the measurement of said security feature according to CIELAB (1976), L* being the lightness value, a* and b* being the color coordinates in a cartesian 2-dimensional space (a*=color value along the red/green axis, wherein negative values are greenish and positive values are reddish; and b*=color value along the blue/yellow axis, wherein negative values are bluish and positive values are yellowish). The L*, a* and b* values were measured with a spectrophotometer DC 45IR from Datacolor (measurement geometry: 45/0°; spectral analyzer: proprietary dual channel holographic grating. 256-photodiode linear arrays used for both reference and sample channels; light source: total bandwidth LED illumination). The following values were obtained: L*: 94.2; a*:−1.9; b*: 5.4

The IR reflectance spectrum of the security feature obtained from the solvent-based security ink CO was measured with the DC45IR from Datacolor between 700 nm and 1100 nm. The 100% reflectance was measured using the internal standard of the device. The obtained data are provided in Table 2B.

The so-obtained security features appeared as very slightly greenish to the naked eye. Such a slight color cast makes the solvent-based thermal drying screen printing security ink CO suitable to provide a machine-readable security feature that is at the same time colorless or slightly colored in the visible domain and strongly absorbing in the near IR domain. Even though said security feature exhibited good optical properties, the ink used to prepare it has the disadvantage of relying on organic solvents, i.e. to necessitate complex ventilation and recycling units and to be inherently more costly and less environmentally friendly.

As mentioned hereabove, the solvent-based thermal drying screen printing security ink CO and security feature obtained thereof have been used as a comparison standard for the optical properties of the security features obtained from the water-based thermal drying screen printing security inks described hereafter. Since the L* values measured for the security features obtained from the inks according to the invention (E1-E17) and comparative inks (C1-C21) were similar to the L* value measured for the solvent-based thermal drying screen printing security ink CO, only the a* and b* value are reported in the following tables.

### B. Water-Based Thermal Drying Screen Printing Security Inks (E1-E17 and C1-C21)

Preparation of Surface Treated IR Absorbing Materials Cu₂PO₄(OH) with Different Ingredient I1-I15

TABLE 1a

| Ix | commercial name and supplier information |
|---|---|
| I1 | HEUCOPHOS ® ZAM-Plus from Heubach: organic modified zinc aluminum molybdenum |
| | orthophosphate hydrate; Zn amount (as ZnO): 60.5-63.5 wt-%; Al amount (as Al₂O₃): 1.0-2.5 wt-%; |
| | P amount (as P₂O₅): 25.5-28.5 wt-%; Mo amount (MoO₃):0.2-0.9 wt-%; pH = 6.0-7.5; average |
| | particle size = 2.0-3.5 microns (see * below) |
| I2 | HEUCOPHOS ® ZCP-Plus from Heubach: zinc calcium strontium aluminum orthophosphate silicate |
| | hydrate; Zn amount (as ZnO): 35.5-39.0 wt-%; Al amount (as Al₂O₃): 2.0-4.0 wt-%; Si amount (as |
| | SiO₂): 14.0-17.0 wt-%; P amount (as P₂O₅): 16.5-19.5 wt-%; Ca amount (as CaO): 13.0-16.0 wt-%; |
| | Sr amount (as SrO): 4.0-6.0 wt-%; pH = 6.5-8.0; average particle size = 2.0-3.5 microns (see * |
| | below) |
| I3 | HEUCOPHOS ® ZAPP from Heubach: zinc aluminum polyphosphate hydrate; Zn amount (as ZnO): |
| | 28.0-31.0 wt-%; Al amount (as Al₂O₃): 11.0-13.0 wt-%; P amount (as P₂O₅): 46.0-49.0 wt-%; pH = |
| | 5.5-6.5; average particle size = 2.0-3.5 microns (see * below) |
| I4 | HEUCOPHOS ® ZPA from Heubach: zinc aluminum orthophosphate hydrate; Zn amount (as ZnO): |
| | 47.9-50.4 wt-%; Al amount (as Al₂O₃): 7.6-10.4 wt-%; P amount (as PO₄³⁻): 53.0-56.0 wt-%; pH = |
| | 5.5-6.5; average particle size = 2.0-3.5 microns (see * below) |
| I5 | 1:1 mixture of HEUCOPHOS ® ZAPP and HEUCORIN ® RZ |
| I6 | HEUCOPHOS ® ZMP from Heubach: zinc molybdenum orthophosphate hydrate; Zn amount (as |
| | ZnO): 66.6-70.3 wt-%; Mo amount (as MoO₃): 1.2-2.2 wt-%; P amount (as PO₄³⁻): 37.0-40.0 wt-%; |
| | pH = 5.5-7.5; average particle size = 2.0-3.5 microns (see * below) |
| I7 | HEUCOPHOS ® ZPO from Heubach: organic modified basic zinc orthophosphate hydrate; Zn |
| | amount (as ZnO): 68.5-72.2 wt-%; P amount (as PO₄³⁻): 37.5-39.5 wt-%; pH = 6.5-7.5; average |
| | particle size = 2.0-3.5 microns (see * below) |
| I8 | HALOX ® Z-PLEX ® 111 from ICL: zinc phosphate complex (no aluminum); 10-25% trizinc |
| | bis(orthophosphate) and 2.5-10% zinc oxide, pH = 8.0, mean particle size = 5.9 microns |
| I9 | HALOX ® Z-PLEX ® 250 from ICL: Zn₃(PO₄)₂•2H₂O; 100% trizinc bis(orthophosphate), Zn amount |
| | (calculated as ZnO): 57.8 wt-%, d50 = 5-7 microns |
| I10 | HALOX ® 430 JM from ICL: calcium phosphate based compound (no zinc, no aluminum), mean |
| | particle size = 2 microns |
| I11 | HEUCORIN ® RZ from Heubach: zinc-5-nitroisophthalate; Zn amount (calculated as ZnO): 54.8 wt-%, |
| | pH = 6.5-8.0, average particle size = 2.0-4.5 microns (see * below) |
| I12 | magnesium chloride MgCl₂ from Sigma-Aldrich |
| I13 | zinc sulfate ZnSO₄•7H₂O from Sigma-Aldrich: Zn amount (calculated as ZnO from anhydrous |
| | compound): 50.4 wt-% |
| I14 | HEUCOPHOS ® SAPP from Heubach: strontium aluminum polyphosphate hydrate; Sr amount (as |
| | SrO): 23.5-30.0 wt-%; P amount (as P₂O₅): 43.5-48.0 wt-%, Al amount (as Al₂O₃): 10.5-13.5 wt-%, |
| | pH = 4.5-6.0, average particle size = 2.0-3.5 microns (see * below) |
| I15 | 1:3 mixture of aluminum sulfate and zinc sulfate Al₂(SO₄)₃•18H₂O and ZnSO₄•7H₂O from Sigma- |
| | Aldrich: Zn amount (calculated as ZnO based on anhydrous compound): 37.8 wt-% and Al amount |
| | (calculated as Al₂O₃ based on anhydrous compound): 7.4 wt-% |

* Zn measured as ZnO (ISO 6745); P as P₂O₅ or PO₄³⁻, respectively, (ISO 6745), and Al as Al₂O₃ (ICP or
complexometric titration)

TABLE 1b

| Ix | commercial name and supplier information |
|---|---|
| I1 | HEUCOPHOS ® ZAM-Plus from Heubach: organic modified zinc aluminum molybdenum |
| | orthophosphate hydrate; Zn amount: 48.6-51.0 wt-%; Al amount: 0.5-1.3 wt-%; P amount: 11.1- |
| | 12.4 wt-%; Mo amount:0.1-0.6 wt-%; pH = 6.0-7.5; average particle size = 2.0-3.5 microns |
| I2 | HEUCOPHOS ® ZCP-Plus from Heubach: zinc calcium strontium aluminum orthophosphate silicate |
| | hydrate; Zn amount: 28.5-31.3 wt-%; Al amount: 1.1-2.1 wt-%; Si amount: 6.5-7.9 wt-%; P amount: |
| | 7.2-8.5 wt-%; Ca amount: 9.3-11.4 wt-%; Sr amount: 3.4-5.1 wt-%; pH = 6.5-8.0; average particle |
| | size = 2.0-3.5 microns |
| I3 | HEUCOPHOS ® ZAPP from Heubach: zinc aluminum polyphosphate hydrate; Zn amount: 22.5-24.9 |
| | wt-%; Al amount: 5.8-6.9 wt-%; P amount: 20.1-21.4 wt-%; pH = 5.5-6.5; average particle size = |
| | 2.0-3.5 microns |
| I4 | HEUCOPHOS ® ZPA from Heubach: zinc aluminum orthophosphate hydrate; Zn amount: 38.5-40.5 |
| | wt-%; Al amount: 4.0-5.5 wt-%; P amount: 17.2-18.3 wt-%; pH = 5.5-6.5; average particle size = |
| | 2.0-3.5 microns |
| I5 | 1:1 mixture of HEUCOPHOS ® ZAPP and HEUCORIN ® RZ; Zn amount: 33.2-34.5; Al amount: 2.9- |
| | 3.5; P amount: 10.0-10.7 wt-% |
| I6 | HEUCOPHOS ® ZMP from Heubach: zinc molybdenum orthophosphate hydrate; Zn amount: 53.5- |
| | 56.5 wt-%; Mo amount: 0.8-1.5 wt-%; P amount: 12.1-13.0 wt-%; pH = 5.5-7.5; average particle |
| | size = 2.0-3.5 microns |
| I7 | HEUCOPHOS ® ZPO from Heubach: organic modified basic zinc orthophosphate hydrate; Zn |
| | amount: 55.0-58.0 wt-%; P amount: 12.2-12.9 wt-%; pH = 6.5-7.5; average particle size = 2.0-3.5 |
| | microns (see * below) |
| I8 | HALOX ® Z-PLEX ® 111 from ICL: zinc phosphate complex (no aluminum); 10-25% trizinc |
| | bis(orthophosphate) and 2.5-10% zinc oxide, pH = 8.0, mean particle size = 5.9 microns |
| I9 | HALOX ® Z-PLEX ® 250 from ICL: Zn₃(PO₄)₂•2H₂O; 100% trizinc bis(orthophosphate), Zn amount: |
| | 46.5 wt-%, d50 = 5-7 microns |
| I10 | HALOX ® 430 JM from ICL: calcium phosphate based compound (no zinc, no aluminum), mean |
| | particle size = 2 microns |
| I11 | HEUCORIN ® RZ from Heubach: zinc-5-nitroisophthalate; Zn amount: 44 wt-%, pH = 6.5-8.0, |
| | average particle size = 2.0-4.5 microns (see * below) |
| I12 | magnesium chloride MgCl₂ from Sigma-Aldrich |
| I13 | zinc sulfate ZnSO₄•7H₂O from Sigma-Aldrich: Zn amount (anhydrous compound): 40.5 wt-% |
| I14 | HEUCOPHOS ® SAPP from Heubach: strontium aluminum polyphosphate hydrate; Sr amount (as |
| | SrO): 19.9-25.4 wt-%; P amount: 19.0-20.9 wt-%, Al amount: 5.6-7.1 wt-%, pH = 4.5-6.0, average |
| | particle size = 2.0-3.5 microns |
| I15 | 1:3 mixture of aluminum sulfate and zinc sulfate Al₂(SO₄)₃•18H₂O and ZnSO₄•7H₂O from Sigma- |
| | Aldrich: Zn amount (anhydrous compound): 30.4 wt-% and Al amount (anhydrous compound): 3.9 wt-% |

0.65 g of the ingredients described in Tables 1 except I13 and I15 were added to 29.9 g of deionized water and dispersed at room temperature using a Dispermat (model LC55) for 15 minutes at 1000 rpm. Subsequently, 12.35 g of the IR-absorbing material was added to each solution and dispersed at room temperature for 15 minutes at 1000 rpm.

1.16 g of ZnSO₄·7H₂O (I13) were added to 29.9 of deionized water. Subsequently 12.35 g of the IR-absorbing material was added and the so-obtained mixture was dispersed at room temperature for 15 minutes at 1000 rpm.

0.32 g of Al₂ (SO₄)₃·18H₂O and 0.87 g of ZnSO₄·7H₂O (ingredients of I15) were added to 29.9 g of deionized water. Subsequently, 12.35 g of the IR-absorbing material was added and the so-obtained mixture was dispersed at room temperature for 15 minutes at 1000 rpm.

The resulting solids were independently filtered and dried in an oven (HERAEUS T6060) for 24 hours at 60° C.

### B1. Influence of Zinc Aluminum Phosphate Compounds (E1-E5 and C1-C11)

The security inks described in Tables 2A-1 and 2A-2 comprised the following compounds:
NeoCryl® XK-98 (DSM Neoresins): aqueous composition comprising an anionic acrylic copolymer (pH: 7.3-7.9, amount of water: 55-57 wt-%)
Ceridust® 3715 (Clariant): ethylene homopolymer wax (CAS no 9002-88-4)
BYK®-345 (BYK): polyether modified dimethylpolysiloxane
Aerosil® 200 (Evonik): hydrophilic fumed silica (CAS no 7631-86-9)
RHEOLATE® 278 TF (Elementis): polyurethane-based thickening agent (25 wt-% active ingredient (CAS not provided), 20 wt-% 2-(2-butoxyethoxy) ethanol, 0.5 wt-% 2,6-di-tert-butyl-P-cresol and 54.5 wt-% water)
TEGO® Foamex 800 (Evonik): emulsion of polyethersiloxane copolymer+SiO₂ (CAS not available) Cu₂PO₄(OH): described hereabove

All the ingredients of the security inks described in Tables 2A-1 and 2A-2 except the IR-absorbing material (Cu₂PO₄(OH) and Cu₂PO₄(OH) surface treated with ingredient Ix of Tables 1) were mixed and dispersed at room temperature using a Dispermat (model LC55) for 15 minutes at 1000 rpm.

The IR absorbing materials were then independently added to the previously obtained composition and dispersed at room temperature using a Dispermat (model LC55) for 15 minutes at 1000 rpm, generating 100 g of the security inks E1-E5 and C1-C11.

The pH values provided in Table 2B were measured with a Metrohm 827 pH lab calibrated with buffers independently having a pH of 4.0, pH 7.0 and pH 9.0.

The viscosity values provided in Table 2B were measured on about 20 g of the security ink at 25° C. on a Brookfield viscometer (model “RVDV-I Prime”), with spindle 21 at 100 rpm for E1, E3, E5, C1-C6, C8-C9 and C11 and with spindle 27 at 100 rpm for E2, E4, C7 and C10.

30 g of the security ink E1-E5 and C1-C11 were independently placed in a 50 ml centrifuge tube (VWR® CT 50 ml) and stored in an oven (HERAEUS T6060) for 30 days at 40° C. so as to mimic about 4 months of ageing at room temperature. Prior to its application on the substrate described hereafter, the inks were left to cool to room temperature.

The security inks described in Tables 2A-1 and 2A-2 were independently applied by hand on a piece of fiduciary paper (BNP paper from Louisenthal, 100 g/m², 14.5 cm×17.5 cm) using a semi-automatic coater (K control coater from RK print, model 001) equipped with bar #3 (theoretical thickness of about 24 μm) and subsequently dried with a hot air drier at a temperature of about 50° C. for about one minute, so as to form a machine readable security feature in the form of a dried coating having a thickness of 6-10 μm and a size of 10 cm×13 cm.

The optical properties Δa* and Δb* of the security features made from the security inks E1-E5 and C1-C11 were measured as described hereabove for the security feature made of the solvent-based security ink C0.

A colorimetric assessment of machine readable security features was done according to the following scale:

| | | | coloristic |
|---|---|---|---|
| shift on a* axis | | shift on b* axis | assessment |
| 0 > Δa* ≥ −0.5 | and/or | 0 < Δb* ≤ 1.5 | 5 |
| −0.5 > Δa* ≥ −0.75 | | 1.5 < Δb* ≤ 2.0 | 4½ |
| −0.75 > Δa* ≥ −1.0 | | 2.0 < Δb* ≤ 3.0 | 4 |
| −1.0 > Δa* ≥ −1.5 | | 3.0 < Δb* ≤ 4.0 | 3½ |
| −1.5 > Δa* ≥ −2.0 | | 4.0 < Δb* ≤ 5.0 | 3 |
| −2.0 > Δa* ≥ −2.5 | | 5.0 < Δb* ≤ 6.0 | 2½ |
| −2.5 > Δa* ≥ −3.0 | | 6.0 < Δb* ≤ 7.0 | 2 |
| −3.0 > Δa* ≥ −3.5 | | 7.0 < Δb* ≤ 8.0 | 1½ |
| Δa* < −3.5 | | Δb* > 8.0 | 1 |

A visual assessment of machine readable security features:

| observed color cast | coloristic assessment | pass |
|---|---|---|
| very slightly greenish | 5 | yes |
| slightly greenish | 4-4.5 | yes |
| slightly greenish, slightly yellowish or | 3-3.5 | no |
| greenish or yellowish | | |
| greenish, yellowish or strongly | 2-2.5 | no |
| greenish or strongly yellowish | | |
| brownish | 1-1.5 | no |

Values (coloristic assessment) below “4” make the machine readable security features unsuitable to provide machine-readable security features that are at the same time colorless or slightly colored in the visible domain and strongly absorbing in the near IR domain.

TABLE 2A-1

| | C1 | E1 | E2 | E3 | E4 | E5 | C2 | C3 |
|---|---|---|---|---|---|---|---|---|
| NeoCryl ® XK-98 | 54.5 | 54.5 | 54.5 | 54.5 | 54.5 | 54.5 | 54.5 | 54.5 |
| deionized water | 28.9 | 27.9 | 27.9 | 27.9 | 27.9 | 27.9 | 27.9 | 27.9 |
| Ceridust ® 3715 | 1.0 | 1.0 | 1.0 | 1.0 | 1.0 | 1.0 | 1.0 | 1.0 |
| BYK ®-345 | 0.5 | 0.5 | 0.5 | 0.5 | 0.5 | 0.5 | 0.5 | 0.5 |
| Aerosil ® 200 | 0.8 | 0.8 | 0.8 | 0.8 | 0.8 | 0.8 | 0.8 | 0.8 |
| RHEOLATE ® 278 TF | 1.3 | 1.3 | 1.3 | 1.3 | 1.3 | 1.3 | 1.3 | 1.3 |
| TEGO ® Foamex 800 | 1.0 | 1.0 | 1.0 | 1.0 | 1.0 | 1.0 | 1.0 | 1.0 |
| Cu₂PO₄(OH) | 12.0 | — | — | — | — | — | — | — |
| Cu₂PO₄(OH) surface | — | 13.0 (I1) | 13.0 (I2) | 13.0 (I3) | 13.0 (I4) | 13.0 (I5) | 13.0 (I6) | 13.0 (I7) |
| treated with | | | | | | | | |
| ingredient Ix (5%) | | | | | | | | |
| ratio R | | 5 | 5 | 5 | 5 | 5 | 5 | 5 |
| viscosity/mPas | 300 | 393 | 700 | 305 | 605 | 368 | 425 | 430 |
| pH | 7.5 | 7.9 | 8 | 7.7 | 7.4 | 7.8 | 7.9 | 8.0 |

TABLE 2A-2

| | C4 | C5 | C6 | C7 | C8 | C9 | C10 | C11 |
|---|---|---|---|---|---|---|---|---|
| NeoCryl ® XK-98 | 54.5 | 54.5 | 54.5 | 54.5 | 54.5 | 54.5 | 54.5 | 54.5 |
| deionized water | 27.9 | 27.9 | 27.9 | 27.9 | 27.9 | 27.9 | 27.9 | 27.9 |
| Ceridust ® 3715 | 1.0 | 1.0 | 1.0 | 1.0 | 1.0 | 1.0 | 1.0 | 1.0 |
| BYK ®-345 | 0.5 | 0.5 | 0.5 | 0.5 | 0.5 | 0.5 | 0.5 | 0.5 |
| Aerosil ® 200 | 0.8 | 0.8 | 0.8 | 0.8 | 0.8 | 0.8 | 0.8 | 0.8 |
| RHEOLATE ® 278 TF | 1.3 | 1.3 | 1.3 | 1.3 | 1.3 | 1.3 | 1.3 | 1.3 |
| TEGO ® Foamex 800 | 1.0 | 1.0 | 1.0 | 1.0 | 1.0 | 1.0 | 1.0 | 1.0 |
| Cu₂PO₄(OH) | — | — | — | — | — | — | — | — |
| Cu₂PO₄(OH) surface | 13.0 (I8) | 13.0 (I9) | 13.0 (I10) | 13.0 (I11) | 13.0 (I12) | 13.0 (I13) | 13.0 (I14) | 13.0 (I15) |
| treated with | | | | | | | | |
| ingredient Ix (5%) | | | | | | | | |
| ratio R | 5 | 5 | 5 | 5 | 5 | 5 | 5 | 5 |
| viscosity/mPas | 330 | 373 | 290 | 545 | 375 | 451 | 620 | 460 |
| pH | 7.8 | 7.6 | 7.7 | 8.0 | 7.3 | 7.8 | 7.7 | 7.8 |

TABLE 2B

| | | | | reflectance (near infrared spectrum) [%] | | | | |
|---|---|---|---|---|---|---|---|---|
| | | | color description | 700 | 800 | 900 | 1000 | 1100 |
| | Δa* | Δb* | assessment/pass | nm | nm | nm | nm | nm |
| C0 | a* value: −1.9 | b* value: 5.4 | very slightly greenish | 71 | 50 | 37 | 34 | 32 |
| | | | 5/yes | | | | | |
| C1 | −2.1 | 9.8 | brownish | 64 | 42 | 30 | 27 | 26 |
| | | | 1/no | | | | | |
| E1 | −1.0 | 2.9 | slightly greenish | 70 | 49 | 37 | 34 | 23 |
| | | | 4/yes | | | | | |
| E2 | −0.9 | 2.9 | slightly greenish | 68 | 45 | 33 | 31 | 27 |
| | | | 4/yes | | | | | |
| E3 | −0.8 | 2.6 | slightly greenish | 67 | 45 | 32 | 29 | 29 |
| | | | 4/yes | | | | | |
| E4 | −0.4 | 2.3 | slightly greenish | 68 | 45 | 32 | 29 | 28 |
| | | | 4/yes | | | | | |
| E5 | −0.6 | 1.9 | slightly greenish | 68 | 44 | 32 | 29 | 28 |
| | | | 4.5/yes | | | | | |
| C2 | −1.2 | 4.6 | slightly greenish, | 67 | 44 | 32 | 29 | 28 |
| | | | yellowish | | | | | |
| | | | 3/no | | | | | |
| C3 | −1.2 | 4.6 | slightly greenish, | 66 | 43 | 30 | 28 | 26 |
| | | | yellowish | | | | | |
| | | | 3/no | | | | | |
| C4 | −1.6 | 5.5 | greenish, yellowish | 68 | 47 | 35 | 32 | 31 |
| | | | 2.5/no | | | | | |
| C5 | −1.2 | 4.0 | slightly greenish, | 69 | 48 | 36 | 33 | 33 |
| | | | slightly yellowish | | | | | |
| | | | 3.5/no | | | | | |
| C6 | −1.6 | 5.8 | greenish, yellowish | 67 | 45 | 33 | 30 | 30 |
| | | | 2.5/no | | | | | |
| C7 | −0.9 | 3.5 | slightly greenish, | 67 | 43 | 31 | 28 | 26 |
| | | | slightly yellowish | | | | | |
| | | | 3.5/no | | | | | |
| C8 | −1.6 | 5.8 | greenish, yellowish | 65 | 42 | 30 | 27 | 26 |
| | | | 2.5/no | | | | | |
| C9 | −1.7 | 6.4 | greenish, yellowish | 67 | 44 | 32 | 29 | 27 |
| | | | 2/no | | | | | |
| C10 | −1.5 | 6.7 | greenish, yellowish | 71 | 51 | 39 | 35 | 33 |
| | | | 2/no | | | | | |
| C11 | −1.6 | 5.6 | greenish, yellowish | 66 | 43 | 31 | 28 | 26 |
| | | | 2.5/no | | | | | |

Δa* and Δb* refer to the color difference with the security feature obtained from the reference security ink C0.

As shown in Table 2B, a security ink (C1) lacking a zinc aluminum phosphate compound suffered from poor optical properties. In particular, the absence of the one or more zinc aluminum phosphate compounds in a water-based security ink C1 resulted in a security feature exhibiting a strong shift towards green (increase of the a* value) and towards yellow (increase of the b* value) in comparison with the comparative solvent-based security ink CO as shown by the Δa* and Δb* values. The observed brownish color of the security feature made from the water-based security ink C1 rendered said security ink unsuitable for manufacturing a machine readable security feature due to a lack of a combination of a colorless or slightly colorless appearance in the visible range and a strong absorbance in the near IR range.

In contrast to security inks lacking a zinc aluminum phosphate compound, the security inks according to the present invention (E1-E5) comprising one or more of said zinc aluminum phosphate compounds in the amount claimed therein allowed to manufacture machine readable security features with very limited color shift in comparison with the security feature obtained from the solvent-based security ink CO. Furthermore, the presence of said one or more zinc aluminum phosphate compounds did not significantly influence their respective IR reflectance spectrum. Accordingly, the security inks according to the present invention (E1-E5) are well suited to provide machine readable security features that are colorless or slightly colored in the visible domain and strongly absorbing in the near IR domain.

The comparative security inks C2-C11 lacking the one or more of zinc aluminum phosphate compounds in the amount claimed therein allowed to manufacture machine readable security features suffering from poor optical properties in the visible range.

### B2. Influence of the Amount of the Zinc Aluminum Phosphate Compounds (E6-E9 and C12-C13)

The required amount of the ingredient I3 of Tables 1 was added to 29.9 g of deionized water and dispersed at room temperature using a Dispermat (model LC55) during for 15 minutes at 1000 rpm. Subsequently, the required amount of the IR-absorbing material Cu₂PO₄(OH) was added and dispersed at room temperature for 15 minutes at 1000 rpm. The resulting solids were independently filtered and dried in an oven (HERAEUS T6060) for 24 hours at 60° C.

All the ingredients of the security inks described in Table 3A except the IR-absorbing material were mixed and dispersed at room temperature using a Dispermat (model LC55) for 15 minutes at 1000 rpm. Subsequently, 13 g of the resulting solids described above were independently added to said composition which was then dispersed at room temperature using a Dispermat (model LC55) for 15 minutes at 1000 rpm, generating 100 g of the security inks E6-E9 and C12-C13. The pH values were measured as described hereabove. The viscosity values were measured at 25° C. on a Brookfield viscometer (model “RVDV-I Prime”, spindle 21 at 100 rpm).

30 g of the security ink E6-E9 and C12-C13 were independently placed in a 50 ml centrifuge tube (VWR® CT 50 ml) and stored in an oven (HERAEUS T6060) for 30 days at 40° C. so as to mimic about 4 months of ageing at room temperature. Prior to printing, the inks were left to cool to room temperature.

The security inks described in Table 3A were independently applied by hand on a piece of fiduciary paper in the form of security features as described hereabove for the security inks E6-E9 and C12-C13. The optical properties Δa* and Δb* of the security features made from the security inks E6-E9 and C12-C13 were measured as described hereabove for the security feature made of the solvent-based security ink C0.

TABLE 3A

| | C1 | C12 | C13 | E6 | E3 | E7 | E8 | E9 |
|---|---|---|---|---|---|---|---|---|
| NeoCryl ® XK-98 | 54.5 | 54.5 | 54.5 | 54.5 | 54.5 | 54.5 | 54.5 | 54.5 |
| deionized water | 28.9 | 27.9 | 27.9 | 27.9 | 27.9 | 27.9 | 27.9 | 27.9 |
| Ceridust ® 3715 | 1.0 | 1.0 | 1.0 | 1.0 | 1.0 | 1.0 | 1.0 | 1.0 |
| BYK ®-345 | 0.5 | 0.5 | 0.5 | 0.5 | 0.5 | 0.5 | 0.5 | 0.5 |
| Aerosil ® 200 | 0.8 | 0.8 | 0.8 | 0.8 | 0.8 | 0.8 | 0.8 | 0.8 |
| RHEOLATE ® 278 TF | 1.3 | 1.3 | 1.3 | 1.3 | 1.3 | 1.3 | 1.3 | 1.3 |
| TEGO ® Foamex 800 | 1.0 | 1.0 | 1.0 | 1.0 | 1.0 | 1.0 | 1.0 | 1.0 |
| Cu₂PO₄(OH) | 12.0 | — | — | — | — | — | — | — |
| Cu₂PO₄(OH) | — | 13.0 (0.5 | 13.0 (1.0 | 13.0 (2.5 | 13.0 (5.0 | 13.0 (8.0 | 13.0 (10.0 | 13.0 (20.0 |
| surface | | wt-% of | wt-% of | wt-% of | wt-% of | wt-% of | wt-% of | wt-% of |
| treated with | | I3 and 99.5 | I3 and 99.0 | I3 and 97.5 | I3 and 95.0 | I3 and 92.0 | I3 and 90.0 | I3 and 80.0 |
| ingredient I3 | | wt-% of | wt-% of | wt-% of | wt-% of | wt-% of | wt-% of | wt-% of |
| | | Cu₂PO₄(OH)) | Cu₂PO₄(OH)) | Cu₂PO₄(OH)) | Cu₂PO₄(OH)) | Cu₂PO₄(OH)) | Cu₂PO₄(OH)) | Cu₂PO₄(OH)) |
| ratio R | | 0.5 | 1.0 | 2.5 | 5.0 | 8.0 | 10.0 | 20.0 |
| viscosity/mPas | 300 | 400 | 390 | 380 | 385 | 375 | 395 | 410 |
| pH | 7.5 | 7.6 | 7.6 | 7.8 | 8.0 | 8.0 | 8.0 | 7.9 |

The 13.0 wt-% of Cu₂PO₄(OH) surface treated with ingredient I3 contained the wt-% of ingredient I3 provided in brackets.

TABLE 3B

| | | | | | reflectance (near infrared spectrum) [%] | | | | |
|---|---|---|---|---|---|---|---|---|---|
| | | | | color description | 700 | 800 | 900 | 1000 | 1100 |
| | ratio R | Δa* | Δb* | assessment/pass | nm | nm | nm | nm | nm |
| C0 | — | a* value: −1.9 | b* value: 5.4 | very slightly greenish | 71 | 50 | 37 | 34 | 32 |
| | | | | 5/yes | | | | | |
| C1 | — | −2.1 | 9.8 | brownish | 64 | 42 | 30 | 27 | 26 |
| | | | | 1/no | | | | | |
| C12 | 0.5 | −1.9 | 9.1 | brownish | 66 | 45 | 32 | 29 | 27 |
| | | | | 1/no | | | | | |
| C13 | 1.0 | −1.0 | 3.1 | slightly greenish, | 68 | 45 | 33 | 30 | 29 |
| | | | | slightly yellowish | | | | | |
| | | | | 3.5/no | | | | | |
| E6 | 2.5 | −0.7 | 2.6 | slightly greenish | 70 | 48 | 36 | 32 | 31 |
| | | | | 4/yes | | | | | |
| E3 | 5.0 | −0.8 | 2.6 | slightly greenish | 67 | 45 | 32 | 29 | 29 |
| | | | | 4/yes | | | | | |
| E7 | 8.0 | −0.7 | 2.3 | slightly greenish | 70 | 48 | 35 | 32 | 31 |
| | | | | 4/yes | | | | | |
| E8 | 10.0 | −0.4 | 1.9 | slightly greenish | 73 | 52 | 40 | 36 | 35 |
| | | | | 4.5/yes | | | | | |
| E9 | 20.0 | −0.2 | 1.5 | very slightly greenish | 75 | 55 | 42 | 39 | 38 |
| | | | | 5/yes | | | | | |

Δa* and Δb* refer to the color difference with the security feature obtained from the reference security ink C0.

As shown in Table 3B, the security inks according to the present invention (E6-E9) comprising one or more of said zinc aluminum phosphate compounds in the amount claimed therein allowed to manufacture machine readable security features with very limited color shift in comparison with the security feature obtained from the solvent-based security ink CO. Furthermore, the presence of said one or more zinc aluminum phosphate compounds did not significantly influence their respective IR reflectance spectrum. Accordingly, the security inks according to the present invention (E6-E9) are well suited to provide machine readable security features that are colorless or slightly colored in the visible domain and strongly absorbing in the near IR domain.

The comparative security inks C12-C13 comprising the one or more of zinc aluminum phosphate compounds in an amount outside the claimed one allowed to manufacture machine readable security features suffering from poor optical properties in the visible range.

B3. Examples with Different Binders Comprising One or More Acrylic Resins (E10-E17 and C14-C21)

The following acrylic resins have been used in the security inks described in Tables 4A-1 and 4A-2:
R1: NeoCryl® XK-98 (DSM): aqueous composition comprising an anionic acrylic copolymer (pH: 7.3-7.9, amount of water: 56 wt-%)
R2: NeoCryl® XK-16 (DSM): aqueous composition comprising an anionic acrylic copolymer (pH: 7.5-8.2, amount of water: 60 wt-%)
R3: NeoCryl® XK-237 (DSM): aqueous composition comprising an anionic acrylic copolymer (pH: 8.0-9.0, amount of water: 56 wt-%)
R4: NeoCryl® BT-100 (DSM): aqueous composition comprising an anionic acrylic copolymer (pH: 1.8-2.8, amount of water: 60 wt-%)
R5: NeoCryl® BT-20 (DSM): aqueous composition comprising an anionic acrylic copolymer (pH: 5.0-6.0, amount of water: 60 wt-%)
R6: Carbobond™ 3005 (Lubrizol): aqueous composition comprising an urethane acrylic copolymer (amount of water: 42 wt-%)
R7: NeoPac™ E-180 (Covestro): aqueous composition comprising an urethane acrylic copolymer (pH=7.5-8.4, amount of water: 67 wt-%)
R8: Zinpol 350 (Worlée): aqueous composition comprising a styrene acrylic copolymer (pH: 8-9, amount of water: 55 wt-%)
R9: Zinpol 460 (Worlée): aqueous composition comprising a styrene acrylic copolymer (pH: 8.0-8.5, amount of water: 50 wt-%).

0.65 g ingredient I3 of Tables 1 was added to 29.9 g of deionized water and dispersed at room temperature using a Dispermat (model LC55) during for 15 minutes at 1000 rpm. Subsequently, 12.35 g of the IR-absorbing material Cu₂PO₄(OH) was added and dispersed at room temperature for 15 minutes at 1000 rpm. The resulting solids were independently filtered and dried in an oven (HERAEUS T6060) for 24 hours at 60° C.

All the ingredients of the security inks described in Tables 4A-1 and 4A-2 except the IR-absorbing material were mixed and dispersed at room temperature using a Dispermat (model LC55) for 15 minutes at 1000 rpm. 13 g of the IR-absorbing material Cu₂PO₄(OH) treated with the ingredient I3 were independently added to said composition which was then dispersed at room temperature using a Dispermat (model LC55) for 15 minutes at 1000 rpm, generating 100 g of the security inks E10-E17. 12 g of the IR-absorbing material Cu₂PO₄(OH) were independently added to said composition which was then dispersed at room temperature using a Dispermat (model LC55) for 15 minutes at 1000 rpm, generating 100 g of the comparative security inks C14-C21. The pH values were measured as described hereabove. The viscosity values were measured at 25° C. on a Brookfield viscometer (model “RVDV-I Prime”) with spindle 21 at 100 rpm for E14, E16, E17, C18, C20 and C21, and with spindle 27 at 100 rpm for E10-E13, E15, C14-C17 and C19.

30 g of the security inks E10-E17 and C14-C21 were independently placed in a 50 ml centrifuge tube (VWR® CT 50 ml) and stored in an oven (HERAEUS T6060) for 30 days at 40° C. so as to mimic about 4 months of ageing at room temperature. Prior to printing, the inks were left to cool to room temperature.

The security inks described in Tables 4A-1 and 4A-2 were independently applied by hand on a piece of fiduciary paper in the form of security features as described hereabove for the security inks E10-E17 and C14-C21.

The optical properties Δa* and Δb* of the security features made from the security inks E10-E17 and C14-C21 were measured as described hereabove for the security feature made of the solvent-based security ink CO.

TABLE 4A-1

| | C1 | E3 | C14 | E10 | C15 | E11 | C16 | E12 | C17 |
|---|---|---|---|---|---|---|---|---|---|
| acrylic resin (Rx) | 54.5 (R1) | 54.5 (R1) | 60.0 (R2) | 60.0 (R2) | 54.5 (R3) | 54.5 (R3) | 41.0 (R4) | 41.0 (R4) | 60.0 (R5) |
| deionized water | 28.9 | 27.9 | 22.9 | 21.9 | 27.2 | 26.2 | 39.0 | 38.0 | 21.7 |
| Ceridust ® 3715 | 1.0 | 1.0 | 1.0 | 1.0 | 1.0 | 1.0 | 1.0 | 1.0 | 1.0 |
| BYK ®-345 | 0.5 | 0.5 | 0.5 | 0.5 | 0.5 | 0.5 | 0.5 | 0.5 | 0.5 |
| Aerosil ® 200 | 0.8 | 0.8 | 0.8 | 0.8 | 0.8 | 0.8 | 0.8 | 0.8 | 0.8 |
| RHEOLATE ® 278 TF | 1.3 | 1.3 | 1.3 | 1.3 | 1.3 | 1.3 | 1.3 | 1.3 | 1.3 |
| TEGO ® Foamex 800 | 1.0 | 1.0 | 1.0 | 1.0 | 1.0 | 1.0 | 1.0 | 1.0 | 1.0 |
| ammonia 25% (w/w) | — | — | — | — | — | — | 5.5 | — | 1.5 |
| Cu₂PO₄(OH) | 12.0 | — | 12.0 | — | 12.0 | — | 12.0 | — | 12.0 |
| Cu₂PO₄(OH) surface | — | 13.0 | — | 13.0 | — | 13.0 | — | 13.0 | — |
| treated with | | | | | | | | | |
| ingredient I3 (5.0%) | | | | | | | | | |
| ratio R | | 5 | | 5 | | 5 | | 5 | |
| viscosity/mPas | 300 | 305 | 1100 | 1200 | 1200 | 1700 | 700 | 720 | 560 |
| pH | 7.5 | 7.7 | 7.4 | 7.3 | 7.6 | 8.0 | 8.3 | 8.3 | 8.0 |

TABLE 4A-2

| | C17 | E13 | C18 | E14 | C19 | E15 | C20 | E16 | C21 | E17 |
|---|---|---|---|---|---|---|---|---|---|---|
| acrylic resin (Rx) | 60.0 (R5) | 60.2 (R5) | 41.35 (R6) | 41.35 (R6) | 72.70 (R7) | 72.70 (R7) | 53.3 (R8) | 53.3 (R8) | 48.0 (R9) | 48.0 (R9) |
| deionized water | 21.7 | 20.7 | 41.55 | 41.55 | 11.85 | 10.85 | 26.9 | 26.9 | 34.9 | 34.9 |
| Ceridust ® 3715 | 1.0 | 1.0 | 1.00 | 1.00 | 1.00 | 1.00 | 1.0 | 1.0 | 1.0 | 1.0 |
| BYK ®-345 | 0.5 | 0.5 | 0.50 | 0.50 | 0.50 | 0.50 | 0.5 | 0.5 | 0.5 | 0.5 |
| Aerosil ® 200 | 0.8 | 0.8 | 0.80 | 0.80 | 0.80 | 0.80 | 0.8 | 0.8 | 0.8 | 0.8 |
| RHEOLATE ® 278 TF | 1.3 | 1.3 | 1.30 | 1.30 | 1.30 | 1.30 | 1.3 | 1.3 | 1.3 | 1.3 |
| TEGO ® Foamex 800 | 1.0 | 1.0 | 1.00 | 1.00 | 1.00 | 1.00 | 1.0 | 1.0 | 1.0 | 1.0 |
| ammonia 25% (w/w) | 1.5 | — | — | — | — | — | — | — | — | — |
| Cu₂PO₄(OH) | 12.0 | — | 12.00 | — | 12.0 | — | 12.0 | — | 12.0 | — |
| Cu₂PO₄(OH) surface | — | 13.0 | — | 13.00 | — | 13.00 | — | 13.0 | — | 13.0 |
| treated with | | | | | | | | | | |
| ingredient I3 (5.0%) | | | | | | | | | | |
| ratio R | | 5 | | 5 | | 5 | | 5 | | 5 |
| viscosity/mPas | 560 | 580 | 350 | 358 | 750 | 700 | 325 | 305 | 295 | 314 |
| pH | 8.0 | 8.0 | 7.9 | 7.8 | 7.8 | 7.8 | 8.0 | 7.9 | 7.7 | 7.9 |

TABLE 4B

| | | | color description |
|---|---|---|---|
| | Δa* | Δb* | assessment / pass |
| C1 | −2.1 | 9.8 | brownish |
| | | | 1 / no |
| E3 | −0.8 | 2.6 | slightly greenish |
| | | | 4 / yes |
| C14 | −2.2 | 5.8 | greenish, yellowish |
| | | | 2.5 / no |
| E10 | −0.6 | 1.6 | slightly greenish |
| | | | 4.5 / yes |
| C15 | −1.0 | 6.6 | strongly yellowish |
| | | | 2 / no |
| E11 | −0.3 | 1.5 | slightly greenish |
| | | | 4.5 / yes |
| C16 | −1.4 | −0.8 | greenish |
| | | | 3.5 / no |
| E12 | 0.1 | −0.3 | very slightly greenish |
| | | | 5 / yes |
| C17 | −2.5 | 0.0 | strongly greenish |
| | | | 2.5 / no |
| E13 | −0.4 | 0.0 | very slightly greenish |
| | | | 5 / yes |
| C18 | −2.1 | −0.1 | strongly greenish |
| | | | 2.5 / no |
| E14 | −0.8 | 0.8 | slightly greenish |
| | | | 4 / yes |
| C19 | −1.4 | 6.8 | strongly yellowish |
| | | | 2 / no |
| E15 | −0.6 | 1.0 | slightly greenish |
| | | | 4.5 / yes |
| C20 | −2.4 | 1.0 | strongly greenish |
| | | | 2.5 / no |
| E16 | −0.8 | 1.5 | slightly greenish |
| | | | 4 / yes |
| C21 | −2.2 | 0.1 | strongly greenish |
| | | | 2.5 / no |
| E17 | −0.6 | −0.1 | very slightly greenish |
| | | | 4.5 / yes |

Δa* and Δb* refer to the color difference with the security feature obtained from the reference security ink C0.

As shown in Table 4B, the security inks according to the present invention (E10-E17) comprising different acrylic resins and one or more of said zinc aluminum phosphate compounds in the amount claimed therein allowed to manufacture machine readable security features with very limited colorshifting properties in comparison with the security feature obtained from the solvent-based security ink CO. Furthermore, the presence of said one or more zinc aluminum phosphate compounds did not significantly influence their respective IR reflectance spectrum. Accordingly, the security inks according to the present invention (E10-E17) are well suited to provide machine readable security features that are colorless or slightly colored in the visible domain and strongly absorbing in the near IR domain.

The comparative security inks C14-C21 comprising different acrylic resins but lacking the one or more of zinc aluminum phosphate compounds allowed to manufacture machine readable security features suffering from poor optical properties in the visible range.

B4. Examples with Different Methods to Prepare the Security Inks (E3, E18-E20)
Method 1: the first method was the same as described above for the security ink E3.
Method 2: the ingredient I3 and the IR-absorbing material were intimately mixed in a mortar. The resulting powder was subsequently added to the acrylic resin and dispersed at room temperature using a Dispermat (model LC55) for 15 minutes at 1000 rpm. The remaining ingredients were then added in the sequence provided in Table 5A (starting with deionized water) and further dispersed at room temperature for 15 minutes at 1000 rpm to generate 100 g of the security ink E18.
Method 3: the ingredient I3 was added to the acrylic resin and dispersed at room temperature using a Dispermat (model LC55) for 15 minutes at 1000 rpm. The IR-absorbing compound was then added and further dispersed at room temperature for 15 minutes at 1000 rpm. The remaining ingredients were then added in the sequence provided in Table 5A (starting with deionized water) and further dispersed at room temperature for 15 minutes at 1000 rpm to generate 100 g of the security ink E20.
Method 4: the ingredient I3 was dispersed in deionized water at room temperature using a Dispermat (model LC55) for 15 minutes at 1000 rpm. The IR-absorbing compound was then added and further dispersed at room temperature for 15 minutes at 1000 rpm. The dispersion was then filtered and the resulting solid was dried in an oven for 24 hours at 60° C. The so-dried solid was then added to the acrylic resin and dispersed using a Dispermat (model LC55) at room temperature for 15 minutes at 1000 rpm. The remaining ingredients were then added in the sequence provided in Table 5A (starting with deionized water) and further dispersed at room temperature for 15 minutes at 1000 rpm to generate 100 g of the security ink E20.

The pH values were measured as described hereabove. The viscosity values were measured at 25° C. on a Brookfield viscometer (model “RVDV-I Prime”) with spindle 21 at 100 rpm for E18 and with spindle 27 at 100 rpm for E19-E20.

30 g of the security inks E18-E20 were independently placed in a 50 ml centrifuge tube (VWR® CT 50 ml) and stored in an oven (HERAEUS T6060) for 30 days at 40° C. so as to mimic about 4 months of ageing at room temperature. Prior to printing, the inks were left to cool to room temperature.

The security inks described in Tables 4A-1 and 4A-2 were independently applied by hand on a piece of fiduciary paper in the form of security features as described hereabove for the security inks E18-E20.

The optical properties Δa* and Δb* of the security features made from the security inks E18-E20 were measured as described hereabove for the security feature made of the solvent-based security ink CO and are provided in Table 5B.

TABLE 5A

| | E3 | E18 | E19 | E20 |
|---|---|---|---|---|
| | 1^{st} method | 2^{nd} method | 3^{rd} method | 4^{th} method |
| NeoCryl ® XK-98 | 54.5 | 54.5 | 54.5 | 54.5 |
| deionized water | 27.9 | 27.9 | 27.9 | 27.9 |
| Ceridust ® 3715 | 1.0 | 1.0 | 1.0 | 1.0 |
| BYK ®-345 | 0.5 | 0.5 | 0.5 | 0.5 |
| Aerosil ® 200 | 0.8 | 0.8 | 0.8 | 0.8 |
| RHEOLATE ® 278 | 1.3 | 1.3 | 1.3 | 1.3 |
| TF | | | | |
| TEGO ® Foamex 800 | 1.0 | 1.0 | 1.0 | 1.0 |
| Cu₂PO₄(OH) | 12.0 | — | — | — |
| ingredient I3 | — | 0.65 | 0.65 | — |
| Cu₂PO₄(OH) | — | 12.35 | 12.35 | — |
| Cu₂PO₄(OH) surface | 13.0 | — | — | 13.0 |
| treated with ingredient | | | | |
| I3 (5.0%) | | | | |
| ratio R | 5 | 5 | 5 | 5 |
| viscosity / mPas | 305 | 305 | 600 | 590 |
| pH | 7.7 | 7.8 | 7.8 | 7.7 |

TABLE 5B

| | | | color description |
|---|---|---|---|
| | Δa* | Δb* | assessment / pass |
| E3 | −0.8 | 2.6 | slightly greenish |
| | | | 4 / yes |
| E18 | −1.0 | 3.0 | slightly greenish |
| | | | 4 / yes |
| E19 | −0.9 | 2.6 | slightly greenish |
| | | | 4 / yes |
| E20 | −0.4 | 2.2 | strongly greenish |
| | | | 4 / yes |

A machine readable security feature was prepared to illustrate one of the possible uses of the claimed security inks. The security ink E3 (after accelerated ageing during 1 month at 40° C.) was applied by hand on a piece of fiduciary paper (BNP paper from Louisenthal, 100 g/m²) using a 90 thread/cm screen (230 mesh). Subsequently, said ink was dried with a hot air drier at a temperature of about 50° C. for about one minute, so as to form an IR-absorbing layer having a thickness of 6-10 μm and having the shape of two circular geometric patterns, as shown in the sole FIGURE (right). On top of the IR-absorbing layer and partially covering it, an IR-transparent layer made of a blue oxidative intaglio ink was applied by hand using an Ormag® intaglio proof press at 65° C. as a portrait, as shown in the sole FIGURE (left). Said second layer was dried 24 hours at room temperature.

The sole FIGURE (left) is a picture of the machine readable security feature under visible artificial light, captured using a phone camera. The second layer made of the dried IR-transparent intaglio ink is well visible, whereas the first layer made of the dried IR-absorbing security ink is invisible.

The sole FIGURE (right) is a picture of the machine readable security feature under near IR light, captured using a near IR camera. The first layer made of the dried IR-absorbing security ink is well visible, whereas the second layer made of the dried IR-transparent intaglio ink is almost invisible.

According to this embodiment, a paper manufacturer could print a covert IR-absorbing layer made of the security ink according to the invention directly on a security substrate (such as cotton paper or BOPP) in the form of an invisible indicium. Subsequently, security printers may apply by one or more printing processes several layers of security inks usually found on a banknote without limitation.

1. A security ink for printing a machine readable security feature, said having a viscosity between 50 and 3000 mPa s at 25° C., a pH between about 7.0 and about 9.0, and comprising:
a) water in an amount of at least about 45 wt-%,
b) a binder comprising one or more acrylic resins, said binder being present in an amount from about 10 wt-% to about 40 wt-%,
c) one or more IR absorbing materials in a total amount from about 5 wt-% to about 25 wt-%,
said one or more IR absorbing materials comprising copper (Cu) and one or more anions selected from the group consisting of phosphates (PO₄³⁻), hydrogenophosphates (HPO₄²⁻), pyrophosphates (P₂O₇⁴⁻), metaphosphates (P₃O₉³⁻), fluorides, chlorides, sulfates (SO₄²⁻) and hydroxides (OH⁻) and
d) one or more zinc aluminum phosphate compounds in an amount from about 0.125 wt-% to about 5.0 wt-%,
wherein a ratio (R) between the amount of the one or more zinc aluminum phosphate compounds versus the sum of the amount of the one or more zinc aluminum phosphate compounds and the one or more IR absorbing materials is between about 2.0 and about 20,
e) optionally one or more additives selected from fillers, waxes, surfactants, anti-foaming agents, thickening agents and mixtures thereof,
the weight percents being based on the total weight of the security ink.

2. The security ink according to claim 1, wherein the ratio (R) is between about 2.5 and about 20.

3. The security ink according to claim 1, wherein at least one of the of the one or more IR absorbing materials is Cu₂PO₄(OH).

4. The security ink according to claim 1, wherein the one or more zinc aluminum phosphate compounds independently comprise from about 15 wt-% to about 60 wt-% of zinc and from about 0.3 wt-% to about 12 wt-% of aluminum and from about 5 wt-% to about 30 wt-% of phosphorus, the weight percents being based on the total weights of said one or more zinc aluminum phosphate compounds.

5. The security ink according to claim 1, wherein the one or more zinc aluminum phosphate compounds independently comprise from about 20 wt-% to about 70 wt-% when calculated as ZnO and from about 0.5 wt-% to about 20 wt-% when calculated as Al₂O₃ and from about 10 wt-% to about 70 wt-% when calculated as P₂O₅ or PO₄³⁻, the weight percents being based on the total weights of said one or more zinc aluminum phosphate compounds.

6. The security ink according to claim 1, wherein at least one of the one or more zinc aluminum phosphate compounds comprises molybdenum, and/or calcium and/or strontium and/or silicon.

7. The security ink according to claim 1, wherein the binder is present in an amount from about 15 wt-% to about 30 wt-%, the weight percents being based on the total weight of the security ink.

8. The security ink according to claim 1, wherein the one or more IR absorbing materials are present in a total amount from about 7 wt-% to about 15 wt-%, the weight percents being based on the total weight of the security ink.

9. The security ink according to claim 1, further comprising one or more further IR absorbing materials selected from the group consisting of
a) compounds comprising one or more transition elements selected from the group consisting of Ti, V, Cr, Mn, Fe, Co, and Ni and one or more anions selected from the group consisting of phosphates (PO₄³⁻), hydrogenophosphates (HPO₄²⁻), pyrophosphates (P₂O₇⁴⁻), metaphosphates (P₃O₉³⁻), polyphosphates, silicates (SiO₄⁴⁻), condensed polysilicates; titanates (TiO₃²⁻), condensed polytitanates, vanadates (VO₄³⁻), condensed polyvanadates, molybdates (MoO₄²⁻), condensed molybdates, tungstates (WO₄²⁻), condensed polytungstates, niobates (NbO₃²⁻), fluorides (F⁻), chlorides (Cl⁻), sulfates (SO₄²⁻) and/or hydroxides (OH⁻);
b) inorganic compounds selected from the group consisting of doped tin oxides, doped indium oxides, reduced tungsten oxides, tungsten bronze;
c) organic compounds selected from the group consisting of phthalocyanine compounds, naphthalocyanine compounds, dithiolene compounds, rylene-based compounds; and
d) mixtures thereof.

10. (canceled)

11. A method for producing a machine readable security feature on a substrate comprising a step a) of applying the security ink recited in claim 1 onto a substrate and b) drying said security ink in the presence of air, infrared or a combination thereof so as to form the machine readable security feature on the substrate, said step of drying being performed after the step a).

12. The method according to claim 11 further comprising a step c) of applying an ink different from the security ink on the machine readable security feature obtained in step b) by a printing process selected from the group consisting of screen printing, gravure printing, intaglio printing, offset printing and combinations thereof and a step d) of curing or hardening said ink of step c) so as to form one or more security features different from the machine readable security feature.

13. A machine readable security feature made from the security ink recited in claim 1 by 1 a method comprising a step a) of applying the security ink onto a substrate and b) drying said security ink in the presence of air, infrared or a combination thereof so as to form the machine readable security feature on the substrate, said step of drying being performed after the step a).

14. A method for authenticating a security document comprising the steps of:
a) providing the security document, comprising the machine readable security feature recited in claim 13 and made of the security ink;
b) illuminating the machine readable security feature at at least one wavelength in the IR range,
c) detecting the optical characteristics of the machine readable security feature through sensing of light reflected by or transmitted through said machine readable security feature at at least one wavelength, wherein one of said at least one wavelength is in the IR range, and
d) determining the security document authenticity from the detected optical characteristics of the machine readable security feature.

15. The method according to claim 14, wherein
step b) consists of illuminating the machine readable security feature at at least two wavelengths, wherein one of said at least two wavelengths is in the visible range and another one of said at least two wavelengths is in the IR range; and
step c) consists detecting the optical characteristics of the machine readable security feature through sensing of light reflected by or transmitted through said machine readable security feature at at least two wavelengths, wherein one of said at least two wavelengths is in the visible range and another one of said at least two wavelengths is in the IR range.

16. The security ink according to claim 1, wherein the one or more anions are selected from the group consisting of phosphates (PO₄³⁻), hydrogenophosphates (HPO₄²⁻), pyrophosphates (P₂O₇⁴⁻), metaphosphates (P₃O₉³⁻), polyphosphates and hydroxides (OH⁻)

17. The security ink according to claim 1, wherein the ratio (R) is between about 2.5 and about 10.

18. The method of claim 11, where in step a), the security ink is applied by screen printing, and wherein the substrate is selected from the group consisting of papers or other fibrous materials, paper-containing materials.

19. The method according to claim 14, wherein the security document is a banknote.

20. The method according to claim 15, wherein in step b) the one of said at least two wavelengths in the IR range is between 780 nm and 3000 nm, and wherein in step c) the one of said at least two wavelengths in the IR range is between 780 nm and 3000 nm.
